(19) United States
(12) Patent Application Publication
(10) Pub. No.: US 2007/0261723 A1
(43) Pub. Date: Nov. 15, 2007

(54) Energy-efficient automatic dishwashing appliances

(76) Inventors: Kenneth Nathan Price, Cincinnati, OH (US); William Michael Scheper, Guilford, IN (US); I-Chun Jennifer Chiao, Mason, OH (US); Julia Elizabeth Ballas, Liberty Twp, OH (US); Michael Stanford Showell, Cincinnati, OH (US); Mario Elmen Tremblay, West Chester, OH (US); Kevin Lindsey Waugh, Bagdad (IR)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/443,698

(22) Filed: Jul. 13, 2006

Related U.S. Application Data
(63) Continuation of application No. 10/222,576, filed on Aug. 16, 2002, now abandoned.
(60) Provisional application No. 60/381,472, filed on May 17, 2002.
(60) Provisional application No. 60/381,455, filed on May 17, 2002.
(60) Provisional application No. 60/381,146, filed on May 17, 2002.
(60) Provisional application No. 60/381,473, filed on May 17, 2002.

(51) Int. Cl. B08B 3/00

(52) U.S. Cl. 134/58 D

(57) ABSTRACT

An automatic dishwashing appliance containing a cell and/or device comprising same for electrolyzing tap water and/or wash and/or rinse liquor for treating tableware to improve cleaning, sanitizing and stain removal. The present invention also relates to methods of use and articles of manufacture.

### CROSS REFERENCE TO RELATED APPLICATIONS

This application is a continuation of U.S. application Ser. No. 10/222,576, filed Aug. 16, 2002 which claims the benefit of U.S. Provisional Application No.'s 60/381,472; 60/381,455; 60,381,146 and 60/381,473 all filed May 17, 2002.

### FIELD OF THE INVENTION

The present invention relates to an automatic dishwashing appliance containing a electrochemical cell and/or device comprising same for electrolyzing tap water, wash and/or rinse liquor, and mixtures thereof, for treating tableware to improve cleaning, sanitizing and stain removal. The present invention also relates to methods of use and articles of manufacture.

### BACKGROUND OF THE INVENTION

Electrochemical cells for use in automatic dishwashing appliances are designed to operate by making use of the water electrolysis process wherein, at the anode-water interface, OH− being present in water due to electrolytic dissociation of water molecules donates an electron to the anode and can be thereby oxidized to oxygen gas which can be removed from the system. As a result, the H+ concentration can be enhanced at the anode-water interface so that H+ enriched acidic water can be produced. In a similar manner, at the cathode-water interface, H+ accepts an electron from the cathode and can be reduced to hydrogen to form hydrogen gas which can be similarly eliminated from the system so that the OH− concentration can be increased at the cathode-water interface whereby OH− enriched alkaline water can be generated. Further, when a halogen-containing water (such as, natural water containing sodium chloride or an aqueous solution of sodium chloride) can be subjected to electrolysis, halogenated mixed oxidants are generated in the electrolyzed water.

The following references disclose use of electrochemical cells: U.S. Pat. No. 5,932,171; U.S. Pat. No. 4,481,086; U.S. Pat. No. 4,434,629; U.S. Pat. No. 4,493,760; U.S. Pat. No. 4,402,197; U.S. Pat. No. 5,250,160; U.S. Pat. No. 5,534,120; U.S. Pat. No. 5,865,966; U.S. Pat. No. 5,947,135; JP Application No. 10057297A; JP Application No. 10179489A; JP Application No. 10033448A; JP Patent No. 09122060; JP Patent No. 2000116587; JP Patent No. 10178491; and EP Application No. 0983806A1.

The following references are also related to electrolyzed water: U.S. Pat. No. 3,616,355; U.S. Pat. No. 4,048,047; U.S. Pat. No. 4,062,754; U.S. Pat. No. 4,100,052; U.S. Pat. No. 4,328,084; U.S. Pat. No. 4,761,208; U.S. Pat. No. 5,314,589; U.S. Pat. No. 5,395,492; U.S. Pat. No. 5,439,576; U.S. Pat. No. 5,954,939 (equiv. EP 711,730); and WO 00/34184.

One problem associated with using an electrochemical cell and/or electrolytic device in an automatic dishwashing appliance, which electrolyzes common tap water alone, can be that the electrolytic efficiency of the electrochemical cell can be greatly reduced as compared to a system that provides an additional halogen source to the incoming tap water. U.S. Pat. No. 5,865,966; U.S. Pat. No. 5,947,135; JP Application No. 10057297A; JP Application No. 10179489A; JP Patent No. 09122060; JP Patent No. 2000116587 and EP Application No. 0983806A1 all use common tap water as a sole source of halogen. A remedy commonly used in the art provides a salt brine tank as a source of halogen for electrolysis of incoming tap water in an automatic dishwashing appliance. U.S. Pat. No. 4,402,197, U.S. Pat. No. 5,250,160, U.S. Pat. No. 5,534,120; and JP Application No. 10033448A all disclose the use of a salt brine tank and/or electrolyte charging system to provide a source of halogen to the electrolysis process. However, the problem with the use of salt brine tanks, such as the above, can be that the appliance design becomes needlessly bulky and expensive to manufacture. Furthermore, periodic filling and maintenance of the salt brine tanks can be required of the consumer, which can be inconvenient.

Another problem with using an electrochemical cell and/or electrolytic device in an automatic dishwashing appliance, which electrolyzes incoming tap water alone, can be that they commonly use partitioned electrochemical cells to produce separate ionized water streams. These patents often require the use of reservoir tanks for storing either acidic and/or alkaline water prior to delivery. U.S. Pat. No. 5,534,120 describes an automatic dishwashing appliance containing an attached, non-partitioned electrochemical cell, which can optionally separate the acidic/alkaline ionized water streams separately in the treatment of dishware. U.S. Pat. No. 5,947,135 describes the use of an automatic dishwashing appliance containing an attached, partitioned electrochemical cell that produces separate anolyte/catholyte streams for cleaning and disinfection of tableware. JP Application No. 10033448A discloses the use of an automatic dishwashing appliance containing an attached, integrated electrochemical cell in conjunction with an alkaline cleaning agent containing enzymes to clean tableware. However, the problem with the use of storage reservoir tanks, such as the above, can be that the appliance design becomes needlessly bulky and expensive to manufacture. Furthermore, periodic maintenance of the tanks can be required of the consumer, which can be inconvenient.

Another problem with using an electrochemical cell and/or electrolytic device in an automatic dishwashing appliance which electrolyzes incoming tap water alone can be that there can be no efficient manner for adding more oxidants to the wash and/or rinse cycle. Typical North American and European automatic dishwashing appliance operating cycles can last over 1 hour. It can be well known that over time - and especially in the presence of soil—the concentration of oxidants in the wash and/or rinse liquor present in a typical appliance having an electrochemical cell becomes reduced within the cycle time of the appliance. The remedy can be to either constantly run the electrochemical cell or to periodically add more electrolyzed water via a storage reservoir of acidic and/or alkaline water. However, the problem with adding more electrolyzed tap water via the cell or a storage reservoir can be that it can be undesirable due to water-savings considerations or because of the concern that the detergency of the wash liquor will become reduced by over-dilution, and will result in unsatisfactory performance and dissatisfaction by the consumer.

Another problem associated with automatic dishwashing appliances can be that, in general, automatic dishwashing appliances are not energy efficient. One reason for the high energy consumption of automatic dishwashing appliances can be that wash and/or rinse liquor needs to be heated to a certain temperature and sustained over a specific period in order to sanitize soiled tableware. A significant problem faced by the makers of automatic dishwashing appliances today can be their inability to meet the lower energy consumption guidelines and/or regulations proposed by the government yet still provide sanitization of soiled tableware.

Another problem with using an electrochemical cell and/or electrolytic device in an automatic dishwashing appliances be they partitioned or non-partitioned, can be that the electrochemical cell will eventually become permanently fouled from scaling and no longer function efficiently. This can be difficult to remedy. Electrodes used in both portioned and/or non-partitioned electrochemical cells employ transition metal catalysts to promote the formation of chlorinated oxidants. Partitioned cells generally employ a membrane, which can be susceptible to becoming degraded by scaling or by other impurities. On the other hand, non-partitioned cells, which lack a membrane, are less prone to fouling than partitioned cells, but are nonetheless not immune from degradation over time.

Several remedies for reversing the effects of electrode fouling have been proposed. For example, JP Application No. 10057297A and U.S. Pat. No. 5,954,939 reduce scale formation in the electrochemical cell by electrode polarity reversal. WO Patent Number 00/64325 and U.S. Pat. No. 4,434,629 incorporate the electrochemical cell as part of a water softening system to reduce scaling. U.S. Pat. No. 5,932,171 provides an electrode cleaning composition, such as a source of acid or other descaler, to purge the electrochemical cell. Such remedies for descaling a electrochemical cell and/or device in automatic dishwashing appliances in the above references can increase the manufacturing cost of the appliance (e.g. polarity reversal, water softeners) or are inconvenient, temporary fixes (e.g. cleaning solutions) that require regular consumer attention. Once the electrochemical cells become permanently fouled and/or cease to function efficiently, consumers should eventually pay for the maintenance and repair of their appliance, which can be often expensive and inconvenient.

Another problem with using an electrochemical cell and/or electrolytic device in an automatic dishwashing appliance, which electrolyzes incoming tap water alone, can be that the halogenated mixed oxidants available are limited to a single oxidizing method that is not the most potent means of oxidization available. U.S. Pat. No. 4,402,197 encompasses in-line generation of hypochlorite from saline using an automatic dishwashing appliance containing an attached, non-partitioned electrochemical cell. However, the electrolysis of tap water or of saline water alone does not include the generation of a significant amount of halogen dioxide, a very potent oxidant useful in bleaching of heavily stained tableware.

Accordingly, there can be a clear need in the art for an automatic dishwashing appliance containing an attached, integrated electrochemical cell and/or attached, integrated electrolytic device which comprises an attached, integrated electrochemical cell (hereinafter “cell and/or device”) that provides a solution to the abovementioned problems. It has now surprisingly been found that the use of an automatic dishwashing appliance that comprises a characteristic selected from the group consisting of electrolyzing recirculated wash and/or rinse liquor; energy-savings in sanitization and disinfection; disposability of electrolytic components; and combinations thereof, offers great advantages to the consumer. Furthermore, in addition to the above characteristics, the automatic dishwashing appliance in the present invention can further comprise a cell and/or device selected from the group consisting of a robust cell, dual-purpose cell, partitioned cell, non-partitioned cell, halogen dioxide producing cell, and combinations thereof.

The present invention meets the needs for treating tableware to provide an improvement in cleaning, sanitizing, and/or stain removal by providing a more efficient alternative to electrolyzing incoming tap water alone. The present invention can increase the activity of halogenated mixed oxidants present in the wash and/or rinse cycle by recirculating the existing wash and/or rinse liquors through the attached, integrated, recirculating electrochemical cell and/or the attached, integrated, electrolytic device comprising a recirculating electrochemical cell (hereinafter “recirculating cell and/or device”) without having to add additional electrolyzed tap water. A key aspect of the present invention can be that activity can be maintained by “recirculation” with respect to the wash/rinse liquors, i.e. rather than simply treating and adding incoming tap water alone. Designing the electrochemical cell and/or device to be recirculating offers distinct advantages over the conventional designs previously described in the art. For example, a recirculating cell and/or device allows a halogenated pro-oxidant to be obtained from the detergent itself and hence eliminates the necessity of having a separate brine tank. In addition, a recirculating cell and/or device fortifies the bleaching capacity of the cleaning system throughout the entire wash and/or rinse cycle by allowing the washing and/or rinsing liquor to be continually regenerated in potent oxidizing species. Therefore, the necessity of having to add or store electrolyzed water in a reservoir can be also eliminated. Thus, space and cost savings in appliance design, along with consumer convenience, can be achieved.

In one aspect of the present invention, an automatic dishwashing appliance can comprise an attached, integrated, dual-purpose electrochemical cell and/or an attached, integrated electrochemical device comprising an attached, integrated dual-purpose electrochemical cell (hereinafter “recirculating, dual-purpose cell and/or device”) that can be used separately, and/or simultaneously in combination with a conventional cell and/or device or recirculating cell and/or device. The recirculating, dual-purpose cell and/or device can continually draw in recirculating wash and/or rinse liquor from the washing basin, electrolyze it, and then re-release it into the washing basin for tableware treatment as a discharge effluent.

For appliances other than automatic dishwashing appliance, there are two references that disclose the use of recirculating electrochemical cells: U.S. Pat. No. 5,250,160 and U.S. Pat. No. 5,932,171. These patents, however, are simply immersion baths whose sole function can be for disinfection or sterilization. They do not teach (a) attached, integrated electrochemical cell and/or electrolytic devices in automatic dishwashing appliances; (b) robust electrochemical cell and/or electrolytic device design; nor (c) the materials used electrode construction. Furthermore, the references lack the essential element required for cleaning tableware, that is, the non-immersive high-shear “sheeting” action of the washing and/or rinsing water found during the operation of the typical automatic dishwashing appliance. This non-immersive high-shear “sheeting” action can be essential for delivering satisfactory cleaning levels to soiled tableware, which consumers expect from an automatic dishwashing appliance.

The present invention also meets the need for treating tableware to provide an improvement in cleaning, sanitizing, and/or stain removal by providing a more energy-efficient automatic dishwashing appliance. The energy-saving, automatic dishwashing appliance (hereinafter “energy-saving appliance”) of the present invention can comprise an attached, integrated, energy-saving electrochemical cell and/or attached, integrated electrolytic device which comprises an attached, integrated energy-saving electrochemical cell (hereinafter “energy-saving cell and/or device”), and can be designed for energy-efficiency by providing reduced energy consumption during operation while still achieving sanitization of tableware. Automatic dishwashing appliances of the present invention do not require sustained high temperatures to achieve sanitization like conventional automatic dishwashing appliances. Thus, automatic dishwashing appliances of the present invention provide for lower total energy consumption.

The present invention also meets the need for treating tableware to provide an improvement in cleaning, sanitizing, and/or stain removal by providing an alternative to having the consumer pay for the repair of their automatic dishwashing appliance once the electrochemical cell becomes fouled. Rather than resorting to inherent means of keeping the same electrochemical cell free from debilitating encrustations, the present invention avoids the problem altogether by using cheap, disposable electrodes designed in such a manner to be conveniently and inexpensively replaced on a regular basis as needed. For instance, the consumer can either replace the attached, integrated, disposable and/or replaceable electrochemical cell and/or the attached, integrated, disposable and/or replaceable electrolytic device (hereinafter “disposable cell and/or device) itself, and/or its disposable components, such as the filter, product, a porous basket, valve, etc. This can be especially advantageous in automatic dishwashing appliances where consumer convenience can be desired. The consumer does not have to rely on temporary solutions that ultimately will require professional maintenance or repair.

The present invention also meets the need by allowing for the production of more potent halogenated mixed oxidants generated by a cell and/or device in the presence of a halogen dioxide salt, thus obviating or significantly reducing the need for hot water and maintaining high sanitizing or disinfecting temperatures. In fact, the present invention can optionally provide a significantly more potent oxidant system produced by electrolyzing a halogen dioxide salt which involves a distinct oxidizing mechanism, i.e. oxygen atom transfer rather than chlorine atom transfer.

The present invention also meets the need by providing a method of treating tableware to provide an improvement in cleaning, sanitizing, and/or stain removal by using an automatic dishwashing appliance comprising a characteristic selected from the group consisting of electrolyzing recirculated wash and/or rinse liquor; energy-savings in sanitization; disposability of electrolytic components; and combinations thereof. Furthermore, in addition to the above characteristics, the method further can comprise an automatic dishwashing appliance comprising a characteristic selected from the group consisting of the use of robust, non-partitioned cell and/or devices, ability to generate halogen dioxide via a halogen dioxide precursor pro-oxidant, and combinations thereof.

The present invention also meets the need by providing an article of manufacture that can supply product refills and replacement components for an automatic dishwashing appliance that contains a disposable cell and/or device that can be easily removed, disposed of, and/or replaced by a new component, such as, a new electrochemical cell and/or new electrolytic device, new filter, new product, new valve, new a porous basket, etc.

### SUMMARY OF THE INVENTION

In one aspect of the present invention, an automatic dishwashing appliance having a washing basin can comprise a source of electrical current supply and a recirculating cell and/or device; wherein the recirculating cell can comprise at least one inlet opening and one outlet opening, and at least one pair of electrodes defining a cell gap comprising a passage formed therebetween through which an aqueous electrolytic solution can flow; and wherein the aqueous electrolytic solution recirculates through the recirculating cell and/or device.

In another aspect of the present invention, an automatic dishwashing appliance can comprise a source of electrical current supply and an energy-saving cell and/or electrolytic device. The energy-saving cell can comprise at least one inlet opening and one outlet opening, and at least one pair of electrodes defining a cell gap comprising a passage formed therebetween through which an aqueous electrolytic solution can flow. The energy-saving appliance has a total energy consumption of less than about 1.8 kWh per operating cycle or less than about 600 kWh per year; and wherein the total energy consumption of the appliance includes any energy used to heat wash and/or rinse liquor in the appliance.

In another aspect of the present invention, an automatic dishwashing appliance comprising a source of electrical current supply, and an attached, integrated, electrochemical cell comprising at least one disposable and/or replaceable component, and/or an electrolytic device comprising a disposable and/or replaceable electrochemical cell; wherein said disposable cell comprising at least one inlet opening and one outlet opening, and at least one pair of electrodes defining at least one cell gap comprising at least one cell passage formed therebetween through which an aqueous electrolytic solution can flow; and wherein when said disposable cell becomes fouled, said disposable cell is removed from said appliance and/or device and replaced, as needed. the disposable cell and/or device can be removed from the device and/or appliance, respectively, and replaced when scaled or fouled.

In another aspect of the present invention, a method comprises sanitizing or disinfecting tableware in automatic dishwashing appliance without requiring additional heating of the wash and/or rinse liquor. The steps of the method can comprise the steps of (a) placing tableware in need of treatment into the appliance; (b) providing an energy-saving appliance containing an energy-saving cell and/or device, the electrochemical cell comprising at least one inlet opening and one outlet opening, and at least one pair of electrodes defining a cell gap comprising a passage formed therebetween through which an aqueous electrolytic solution can flow; (c) providing the aqueous electrolytic solution in fluid communication within the energy-saving cell and/or device via the inlet opening; (d) electrolyzing the aqueous electrolytic solution in the energy-saving cell and/or device to produce at least some electrolyzed water; (e) discharging the at least some electrolyzed water into the washing basin of the dishwashing appliance at a specific time or times in the wash and/or rinse cycle; (f) applying no additional heat to the wash and/or rinse liquor in the wash and/or rinse cycle(s) of the appliance; (g) contacting the tableware in need of treatment with the wash and/or rinse liquor comprising at least some electrolyzed water; and (h) optionally repeating steps (c) through (g) until the tableware are treated.

In yet another aspect of the present invention, an article of manufacture can comprise (a) a component selected from the group consisting of an electrochemical cell and/or electrolytic device refill and/or replacement cartridge, product refill and/or replacement cartridge, filter, elastomeric slit valve, a porous basket comprising product for dispensing, and combinations thereof, (b) information and/or instructions in association with the article comprising the steps describing the use of an electrochemical cell and/or electrolytic device, electrolytic solution, detergent and/or rinse aid composition, replaceable component, and combinations thereof, in an automatic dishwashing appliance comprising an electrolytic device for treating tableware for improved cleaning, sanitizing, and/or stain removal. (c) a component selected from the group consisting of suds suppressor, perfume, a bleach-scavenging agent, a metal-protecting agent, and mixtures thereof, and mixtures thereof; and (d) a component selected from the group consisting of an electrolytic composition comprising chloride ions, an electrolytic composition comprising chlorite ions, an electrolytic composition comprising salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, an electrolysis precursor compound, an electrolysis salt with low water solubility, an electrolysis precursor compound contained within a medium for controlled release, and (e) mixtures thereof.

The following description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The present invention is not intended to be limited to the embodiments shown. Thus, since the following specific embodiments of the present invention are intended only to exemplify, but in no way limit, the operation of the present invention, the present invention can be to be accorded the widest scope consistent with the principles, features and teachings disclosed herein.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The various advantages of the present invention will become apparent to those skilled in the art after a study of the foregoing specification and following claims. The following specific embodiments of the present invention are intended to exemplify, but in no way limit, the operation of the present invention. All documents cited are, in relevant part, incorporated herein by reference; the citation of any document is not to be construed as an admission that it can be prior art with respect to the present invention.

### BRIEF DESCRIPTION OF THE DRAWINGS

The invention will now be explained in detail with reference to the accompanying drawings, in which:

FIG. 1 shows an automatic dishwashing appliance with two electrochemical cells; one capable of electrolyzing tap water alone and the other a recirculating electrochemical cell capable of electrolyzing wash and/or rinse liquor.

FIG. 1a shows a recirculating, electrochemical cell.

FIG. 2 shows an automatic dishwashing appliance with a recirculating, dual-purpose cell capable of electrolyzing tap water and/or recirculated wash and/or rinse liquor.

FIG. 2a a showing a recirculating, dual-purpose cell.

FIG. 3 shows an automatic dishwashing appliance with an automatic dishwashing appliance containing an attached, electrochemical cell integrated in the door of the appliance.

FIG. 4 shows an attached, integrated electrolytic device.

FIG. 4a shows the contents of an attached, integrated electrolytic device.

FIG. 5 shows a porous basket comprising product for dispensing.

FIG. 6 shows a non-partitioned electrochemical cell.

FIG. 7 shows cross-section of a non-partitioned electrochemical cell.

FIG. 8 shows an annular, non-partitioned electrochemical cell.

### DETAILED DESCRIPTION OF THE INVENTION

Definitions

“Attached,” integrated cells and/or devices are those that are mechanically integrated into the automatic dishwashing appliance and which draw their electrical power from the electrical power supply of the appliance itself.

“Electrolytic solution” means an aqueous solution capable of being electrolyzed. In its broadest use in the present invention, an aqueous electrolytic solution can be any chemically compatible solution that can flow through the passage of the electrochemical cell, and that contains sufficient electrolytes to allow a measurable flow of electricity through the solution. Water, except for deionized water, can be a preferred electrolytic solution, and can include: sea water; water from rivers, streams, ponds, lakes, wells, springs, cisterns, etc., mineral water; city or tap water; rain water; and brine solutions. An aqueous electrolytic solution of the present invention can be chemically compatible if it does not chemically explode, burn, rapidly evaporate, or if it does not rapidly corrode, dissolve, or otherwise render the cell and/or device unsafe or inoperative, in its intended use in the automatic dishwashing appliance.

“Fluid communication” means that electrolytic solution can flow between the two objects between which the fluid communication can be defined.

“Integrated” means that cell and/or device and all its elements are substantially incorporated into the automatic dishwashing appliance. An automatic dishwashing appliance containing a cell and/or device can be preprogrammed to operate according to a specific wash and/or rinse cycle during operation of a specific automatic dishwashing appliance or can be controlled manually to provide a continuous source of electrolyzed water. A timer can be activated to start and stop the electrolysis process. The timer can be mechanical, electrical or electronic. A sensor can also be employed to activate or deactivate the electrolysis process according to a specific time period during the wash and/or rinse cycle of the appliance.

“Non-buoyant” means negatively buoyant (i.e., the device will not float to the surface of the reservoir but will sink to the bottom) and neutrally buoyant (i.e., the device will remain submerged and substantially stationary in the reservoir electrolytic solution). A “buoyant” device will float quickly to the surface of the reservoir.

“Recirculation” means to circulate again.

“Reservoir” means any body of water artificially confined. An example can include the wash and/or rinse liquor located in the washing basin of an automatic dishwashing appliance.

“Robust” means that the cell and/or device can be designed for longer operating life, being less prone to fouling and scaling than conventional cells and/or devices.

“Sanitization” or “disinfection” means the elimination of nearly all microbial forms, but not necessarily all. Sanitization does not ensure overkill and lacks the margin of safety achieved by sterilization. The automatic dishwashing appliance of the present invention can be capable of sequentially and/or continuously treating tableware with electrolyzed water to provide tableware sanitization and/or disinfection.

“Sterilization” means the destruction of all microbial life, including bacterial spores.

“Treatment” means contacting tableware in need of treatment with tap water, wash and/or rinse liquor, recirculated wash and/or rinse liquor, and mixtures thereof, comprising at least some electrolyzed water for purposes of providing the benefits of tableware cleaning, sanitization and stain removal.

“Tableware” means any type of dishware and/or cookware, including, but not limited to, those made from glass, ceramic, metal, wood, porcelain, etc., as well as, any type of silverware which includes all types made from metal, wood, glass, ceramic, porcelain, etc. Tableware can include, but is not limited to, cooking and eating utensils, dishes, cups, bowls, glasses, silverware, pots, pans, etc.

Detailed Description of the Figures

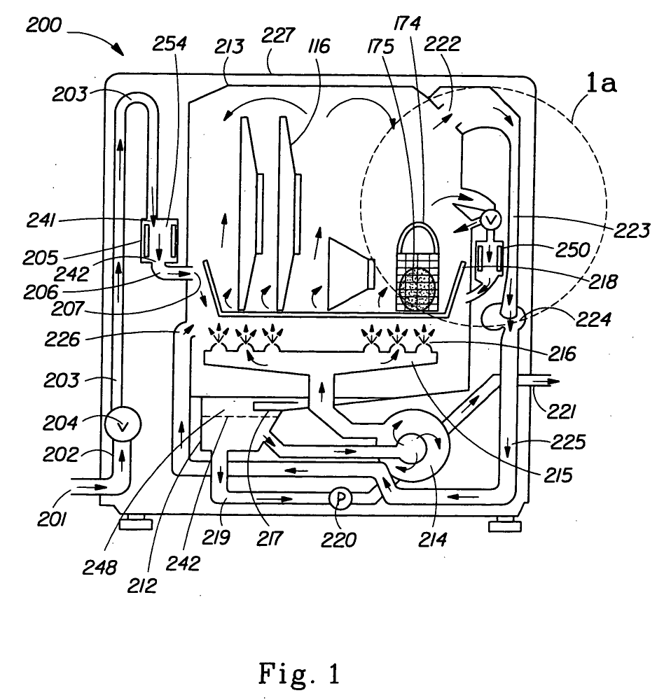

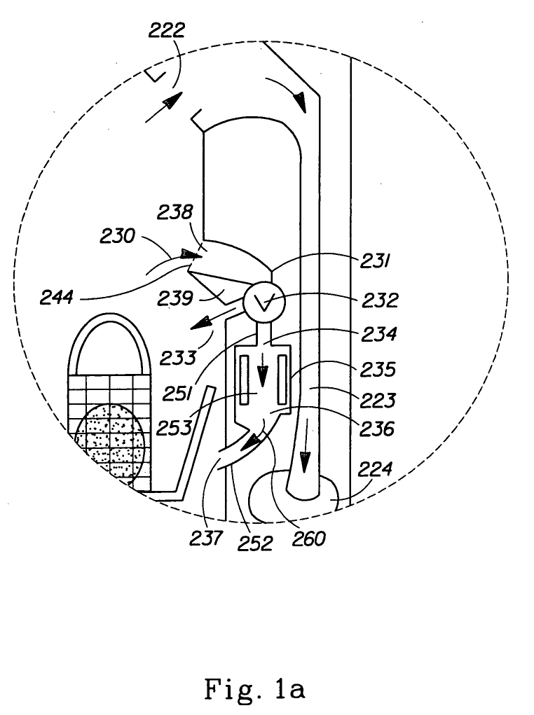

Automatic dishwashing appliance 200 of FIG. 1 and FIG. 1a can be covered with a door (not shown) and a main body cover, 227, and has a washing vessel, 213, therein. A rack, 218, for accommodating tableware to be washed, a rotary washing nozzle, 215, located under rack, 218, and protruding approximately at the center of washing vessel, 213, and a heater, 217, for heating washing water, 248, stored in washing basin, 212, are provided in washing vessel, 213, a plurality of washing water injection openings, 216, are provided on washing nozzle, 215, a recirculated wash and/or rinse liquor collection tray, 239, for collecting recirculated wash and/or rinse liquor, 230, an optional filter, 244, for screening food debris, and an inlet port, 238, and an outlet port, 237. In addition, automatic dishwashing appliance, 200, includes, within the automatic dishwashing appliance itself but outside washing vessel, 213, a circulating pump, 214, for supplying washing water, 248, stored in washing basin, 212, of the washing vessel, 213, to nozzle, 215, a drain pump, 220, for discharging washing water, 248, in washing basin, 212, from a drain pipe, 219, into a drain pipe, 221, and a blower, 224, for sucking air in washing vessel, 213, through an air inlet port, 222, and a sucking duct, 223, and blowing the sucked air into washing vessel, 213, through an air duct, 225, and an air outlet port, 226, to dry the washed tableware.

Automatic dishwashing appliance, 200, further includes, within the automatic dishwashing appliance itself but outside washing vessel, 213, at least one electrochemical cell. The automatic dishwashing appliance can contain electrochemical cell, 205, for producing electrolyzed water, 240, from tap water, 201, water feed pipes, 202 and 203, for externally supplying incoming tap water, 201, to electrochemical cell, 205, a valve, 204, for controlling supply of tap water, 201, to the washing vessel, 213, itself or to the inlet opening, 241, of the electrochemical cell, 205, for electrolysis. The controller (not shown) can provide for periodic cell self-cleaning of the cell, 205, by opening valve, 204, and allowing water to flush the cell passage, 254, and be discharged into the washing basin without applying power for electrolyzation. This self-cleaning can occur periodically throughout the operation of the appliance as needed.

The automatic dishwashing appliance can also contain a recirculating cell, 235, for producing electrolyzed, recirculated wash and/or rinse liquor, 260, from recirculated wash and/or rinse liquor, 230, for internally supplying recirculated wash and/or rinse liquor, 230, to recirculating cell, 235, a filter, 244, covering the inlet port, 238, of the recirculated wash and/or rinse liquor collection tray, 239, a duct or tube, 231, for directing recirculated wash and/or rinse liquor, 230, to a valve 232, for controlling supply of recirculated wash and/or rinse liquor, 230, to the inlet opening, 234, of the recirculating cell, 235, itself or to the bypass outlet, 233, to the washing vessel, 213. An inlet opening, 234, or the recirculating cell, 235, a cell passage, 253, formed therebetween from at least one pair of electrodes defining a cell gap for electrolyzing wash and/or rinse liquor, an outlet opening, 236, for connecting recirculating cell, 235, with washing vessel, 213, via a duct or pipe, 252, an outlet port, 237, for supplying electrolyzed recirculated wash and/or rinse liquor, 260, from recirculating cell, 235, to washing vessel, 213. Note that the automatic dishwashing appliances described herein can contain any combination of cells and/or devices described herein. Furthermore, self-cleaning of the recirculating cell, 235, can be accomplished by attaching a tap water supply (not shown) to the recirculating cell, 235, via the inlet opening, 234, or by a separate inlet opening (not shown) to allow for periodic flushing of the recirculating cell, 235, with tap water to remove food debris deposited in the cell passage, 253, by the recirculating wash and/or rinse liquors, 230. Similarly, self-cleaning of the recirculating filter, 244, can be accomplished by directing a tap water supply (not shown), such as in the form of a jet (not shown), above or below the filter, 244, to remove food debris deposited during collection of the recirculating wash and/or rinse liquor, 230, by spraying the tap water (not shown) at the filter, 244.

The tableware washing and/or rinsing operation of automatic dishwashing appliance, 200, can be carried out based on the control of the microcomputer (not shown). Since washing and/or rinsing of tableware by automatic dishwashing appliance, 200, can consist of a plurality of washing and/or rinsing steps, such a function as to coordinate the production of a proscribed amount of electrolyzed water, 240 and/or 260, required for each washing and/or rinsing step can be provided by a controller (not shown) having a microcomputer (not shown) for controlling a series of operations by automatic dishwashing appliance, 200.

Note that valves, 204 and 232, are in a closed state in an initial state. When a power supply switch (not shown) of an operation panel (which is not shown) can be turned on, valve, 204 and/or 232, can be brought into an open state, tap water, 201, supplied from a tap of a water pipe can be supplied through water feed pipe, 202, valve, 204, and water feed pipe, 203, to electrochemical cell, 205, and voltage can be applied to electrochemical cell, 205, or recirculated wash and/or rinse liquor, 230, supplied from a recirculated wash and/or rinse liquor collection tray, 239, filter, 244, inlet port, 238, and tube or duct, 231, to the inlet opening, 234, of recirculating cell, 235, and voltage can be applied to recirculating cell, 235. Thus, tap water, 201, can be electrolyzed in electrochemical cell, 205, and electrolyzed water, 240, can be produced as a discharge effluent at specific time intervals throughout the wash and/or rinse cycles of the appliance operation. Similarly, recirculated wash and/or rinse liquor, 230, supplied can be electrolyzed in recirculating cell, 235, and electrolyzed recirculated wash and/or rinse liquor, 260, can be produced as a discharge effluent at specific time intervals throughout the wash and/or rinse cycles of the appliance operation.

Depending on the need or desired mode selected, the controller (not shown) can optionally provide for the electrolyzation of both the tap water, 201, and the recirculated wash and/or rinse liquor, 230, simultaneously or in sequential combination to produce electrolyzed tap water, 240 and/or electrolyzed recirculated wash and/or rinse liquor, 260, as a discharge effluent during the wash and/or rinse cycle of the automatic dishwashing appliance, 200. In this case, both valves, 204 and 211, can be opened, simultaneously or in sequential combination, allowing both tap water, 201, and recirculated wash and/or rinse liquor, 230, to be electrolyzed.

Note that if un-electrolyzed tap water, 201, alone can be required during the wash and/or rinse cycle, the controller (not shown) will open valve, 204, to supply tap water, 201, to feed pipe, 243, which directly opens into washing vessel, 213, to provide washing water, 248. In this case, no electrolyzed water can be present in the washing water, 248, since the tap water, 201, bypasses the electrochemical cell, 205. Note that valve, 204, can be opened such as to provide tap water, 201, to both feed pipes, 203 and 243, simultaneously, to allow for partial electrolyzation of at least some the incoming tap water, 201.

Electrolyzed tap water, 240, and/or electrolyzed recirculated wash and/or rinse liquor, 260, produced by application of voltage to electrochemical cell, 205 and/or recirculating cell, 235, can be directed from outlet port, 207 and/or 237, into washing vessel, 213, by inflow pressure of tap water, 201, by mass transport, by pump (not shown), and/or by gravity feed. For sanitization purposes heater, 217, can not be required to be turned on during the wash and/or rinse cycle, due to the halogenated mixed oxidants present in the washing water, 248, comprising electrolyzed tap water, 240 and/or electrolyzed recirculated wash and/or rinse liquor, 260. For other purposes such as cleaning and stain removal, the heater, 217, can be optionally turned on to heat the washing water, 248, in response to the controller (not shown), timer (not shown) and/or sensor (not shown) detecting a change in the fluid or gaseous environment within automatic dishwashing appliance, 200, or the electrochemical cell, 205 and/or 235. With the detection of a specified stimulus, such as a proscribed water level or pH level of the washing water, 248, the circulating pump, 214, can be operated while the washing water, 248, optionally comprising electrolyzed tap water, 240 and/or electrolyzed recirculated wash and/or rinse liquor, 260, can be heated to a proscribed temperature. Note that detection of the water level of washing water, 248, in washing vessel, 213, can be carried out by provision of a float switch type water level sensor (not shown), by the controller (not shown) and/or by water supply time measured with a timer (not shown). Note that a turbidity sensor, water hardness sensor, pH sensor, conductivity sensor, and combinations thereof (not shown), can be used to detect a change in the fluid, the gaseous environment within automatic dishwashing appliance, 200, the electrochemical cell, 205 and/or 235, and/or the electrolytic device (not shown).

Tap water, 201, containing electrolyzed water, 240, and/or recirculated wash and/or rinse liquor, 230, containing electrolyzed wash and/or rinse liquor, 260, can be injected with rotation from injection openings, 216, through washing nozzle, 215, whereby tableware placed in rack, 218, can be treated with electrolyzed tap water, 240, and/or electrolyzed recirculated wash and/or rinse liquor, 260, at specific intervals during the wash and/or rinse cycles of the automatic dishwashing appliance, 200. When washing and/or rinsing for proscribed time can be completed, circulating pump, 214, can be stopped. Then, drain pump, 220, can be operated, and wash and/or rinse liquor, 230, containing used electrolyzed tap water, 240, and/or electrolyzed recirculated wash and/or rinse liquor, 260, can be discharged from drain pipe, 221, through drain pipe, 219, and drain pump, 220. When discharging the wash and/or rinse liquor, 230, is completed, drain pump, 220, can be deactivated.

During a second and/or subsequent wash and/or rinse cycle, valve, 204, can optionally be brought into an open state, allowing tap water, 201, to flow through feed pipe, 243, to washing vessel, 213, filling washing basin, 212, to a proscribed level. Valve, 204, can then be brought into a closed state. Note that valve, 204, can be opened for a specific amount of time and then closed to induce self-cleaning of the recirculating cell as described above, at any time during the operation of the appliance. The application of electrical power to the cell is not necessary during the cell self-cleaning process.

Valve, 232, can simultaneously and/or in sequential combination with the operation of valve, 204, be optionally brought into an open state, recirculated wash and/or rinse liquor, 230, collected by the recirculated wash and/or rinse liquor collection tray, 239, passing through the filter, 244, inlet port, 238, duct or tube, 231, feed pipe, 208, into the cell passage, 253, through inlet opening, 234, of recirculating cell, 235, and voltage can be applied to electrochemical cell, 205, wherein electrolyzed recirculated wash and/or rinse liquor, 260, can be produced and discharged from the outlet opening, 236, the duct or tube, 260, the outlet port, 237, into the washing vessel, 213, and collected in the washing basin, 212, for additional recirculation.

Subsequent washing and/or rinsing steps can be carried out in a manner similar to that of the first one. Thus, the number of steps required can be carried out, whereby washing and/or rinsing can be completed. To put drying after the completion of washing and/or rinsing step briefly, blower, 224, can be first operated, and air in washing vessel, 213, can be sucked from air inlet port, 222, through sucking duct, 223, and directed through blower, 224, air duct, 225, and air outlet port, 226, into washing vessel, 213, to absorb heat energy of heater, 217, while circulating in washing vessel, 213, for proscribed time, whereby drying of the tableware can be completed.

Thus, in automatic dishwashing appliance, 200, of FIG. 1 and FIG. 1a, while electrolyzed tap water, 240, can be produced by electrochemical cell, 205, electrolyzed tap water, 240, will not be discarded being unused, and water can be saved. This can be especially true for electrolyzed recirculated wash and/or rinse liquor, 260. The water-saving benefit occurs when recirculated wash and/or rinse liquor, 230, can be used as the aqueous electrolytic solution. In this case, an increase in the activity of halogenated mixed oxidants can be delivered to the recirculating wash and/or rinse liquor during the wash and/or rinse cycle of the automatic dishwashing appliance, 200. Water can be saved by recirculating the existing wash and/or rinse liquor, 230, through the recirculating cell, 235, without having to add additional electrolyzed tap water, 240. Recirculation also promotes the benefits of cleaning, sanitizing, and stain removal by preventing excessive dilution of the wash and/or rinse liquor, 230, during operation of the automatic dishwashing appliance, 200. Because the heater, 217, is not required for sanitization purposes, automatic dishwashing appliance, 200, achieves energy-savings by reducing the total energy consumption at least less than about 1.8 kWh per operating cycle or about 600 kWh per year, preferably less than about 1.7 kWh per operating cycle or about 555 kWh per year, most preferably can be less than about 1.2 kWh per operating cycle or about 400 kWh per year.

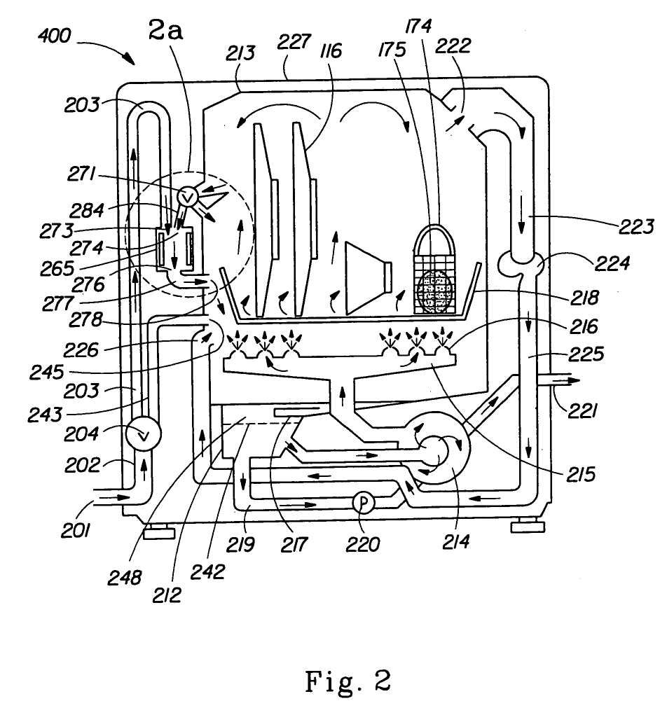

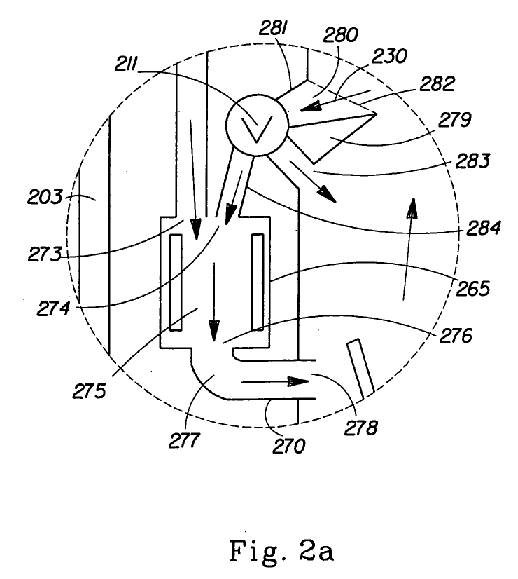

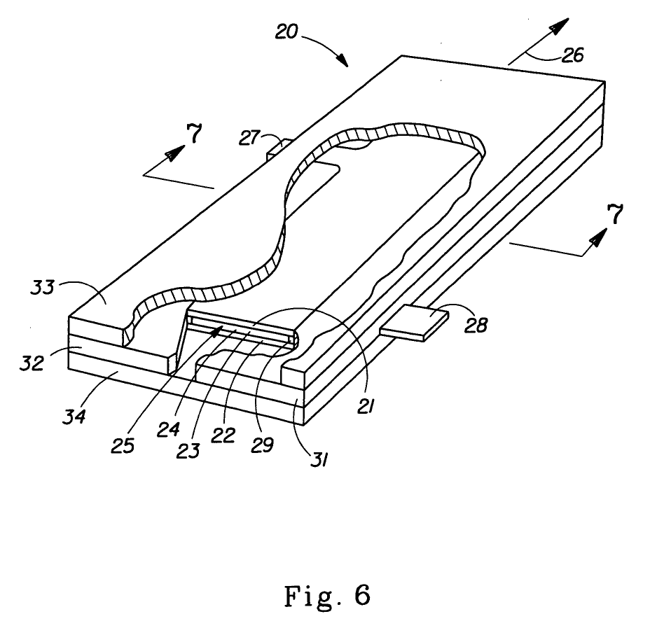

The automatic dishwashing appliance, 400, of FIG. 2 and FIG. 2a and its operation will now be described, but only the differences will be described for simplicity. The automatic dishwashing appliance, 400, further includes, within the automatic dishwashing appliance itself but outside washing vessel, 213, a recirculating, dual-purpose cell, 265, having at least one inlet opening. Though the recirculating, dual-purpose cell, 265, of the present invention can be partitioned or non-partitioned, for clarity the recirculating, dual-purpose cell, 265, depicted in FIG. 2 and FIG. 2a differs only from the non-partitioned electrochemical cell, 20, in FIG. 6 in its ability to electrolyze both tap water, 201, and/or recirculated wash and/or rinse liquor, 230, separately and/or in combination.

For illustrative purposes only, FIG. 2 and FIG. 2a depict a dual-purpose cell with two inlet openings, 273 and 274. The recirculating, dual-purpose cell, 265, has at least one cell passage, 275, defined by a gap between at least one pair of electrodes. Since each electrode can be turned into an anode or a cathode by application of voltage, electrolyzed water can be produced in each cell passage, 275, and discharged through outlet opening, 276. Since the cell passage, 275, for producing electrolyzed water, 270, (as a discharge effluent) can be connected through outlet port, 278, via outlet opening, 276, a duct or tube, 277, to washing vessel, 213, electrolyzed water, 270, can be supplied to washing vessel, 213, while being produced. Note that tap water, 201, or recirculated wash and/or rinse water, 230, and mixtures thereof, can be used as the aqueous electrolytic solution for producing electrolyzed water, 270.

The recirculating, dual-purpose cell, 265, can produce two kinds of electrolyzed water, 270, as a discharge effluent from either tap water, 201, and/or from recirculated wash and/or rinse liquor, 230. Water feed pipe, 202, for externally supplying incoming tap water, 201, to valve, 204, for controlling supply of tap water, 201, to the washing vessel, 213, itself by way of water feed pipe, 243, and outlet port, 245, or to the inlet opening, 273, of the electrochemical cell, 265, for electrolyzation via water feed pipe, 203. A duct or tube, 281, for directing recirculated wash and/or rinse liquor, 230, collected through the inlet port, 280, through filter, 282, to valve, 271, for controlling flow of the recirculated wash and/or rinse water, 230, to the inlet opening, 274, of the recirculating, dual-purpose cell, 265, via a feed pipe, 284, for electrolyzation or to the bypass outlet, 283, for discharge to the washing vessel, 213. The recirculating, dual-purpose cell, 265, can separately and/or simultaneously electrolyze tap water, 201, and/or recirculated wash and/or rinse liquor, 230, in the cell passage, 275. Voltage can be applied to electrochemical cell, 265, wherein electrolyzed water, 270, can be produced, comprising electrolyzed water from recirculated wash and/or rinse liquor, 230, tap water, 201, and mixtures thereof, and discharged from the outlet opening, 276, the duct or tube, 277, the outlet port, 278, into the washing vessel, 213, and collected in the washing basin, 212, for treatment of tableware.

Optionally, at specific time intervals throughout the wash and/or rinse cycles of the appliance operation, valve, 271, can be brought into the open state, recirculated wash and/or rinse liquor, 230, supplied from the washing vessel, 213, can be collected during operation by wash and/or rinse liquor collection tray, 279, filter, 282, and an inlet port, 280, through tube or duct, 281, to valve, 271, and feed pipe, 284, to recirculating, dual-purpose cell, 265, and voltage can be applied to electrochemical cell, 265. Thus, only recirculated wash and/or rinse liquor, 230, supplied can be electrolyzed in recirculating, dual-purpose cell, 265, and electrolyzed water, 270, can be produced as a discharge effluent. This option provides water-savings benefits, maintenance of high levels of halogenated mixed oxidants and eliminates a risk in reducing detergency through dilution.

Self-cleaning of the dual purpose cell, 265, and any other electrochemical cell in general, can be accomplished by any means including but not limited to opening valve, 204, to allow for periodic flushing of the food debris deposited in the cell passage, 275, from the recirculating wash and/or rinse liquor, 230. A separate tap water supply (not shown) can also be provided and directed to the recirculating portion of the dual-purpose cell, 265, to aid in self-cleaning of both the recirculating portion of the dual-purpose cell, 265, or the filter, 282. The self-cleaning feature relies on the pressure of tap water to clean the filter, as described above, or the interior passages of the dual-purpose cell, 265. The tap water can be sprayed by a nozzle (not shown) to aid in self-cleaning.

As an alternative to simply having an automatic dishwashing appliance contain an attached, integrated electrochemical cell alone, an automatic dishwashing appliance of the present invention can contain an attached, integrated electrolytic device, which comprises an electrochemical cell.

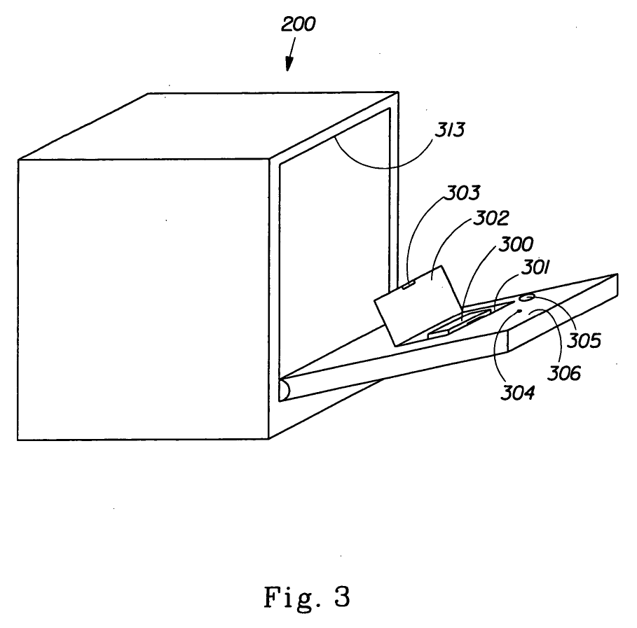

FIG. 3 depicts an automatic dishwashing appliance, 200, having an automatic dishwashing appliance containing an electrolytic device, 300, located in a sealed or sealable compartment, 301, with a sealable cover, 302, and cover latch, 303, in the door, 306, of the automatic dishwashing appliance, 200. The electrolytic device, 300, can be electronically connected to a replacement indicator lamp, 304, located on the interior surface of the door, 306, which can alert the consumer to the need to replace the electrolytic device, 300, itself and/or a disposable electrolytic component (not shown) within cell and/or device, 300. For simplicity, the electrochemical cell is not shown but it is understood that it is in fluid communication with the washing water of the appliance, which can comprise tap water, rinse and/or wash liquor, washing water, or mixtures thereof via the necessary elements and components, such as pumps and piping.

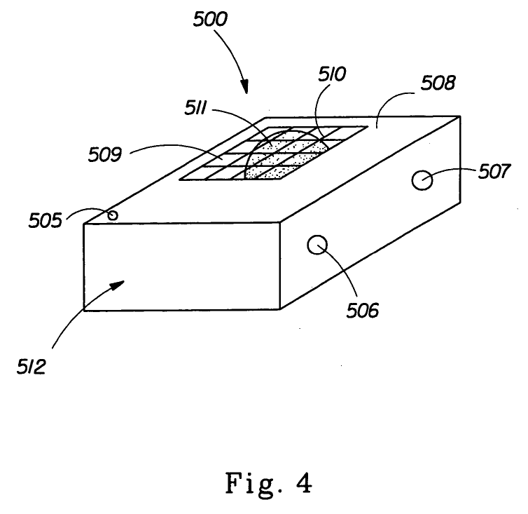

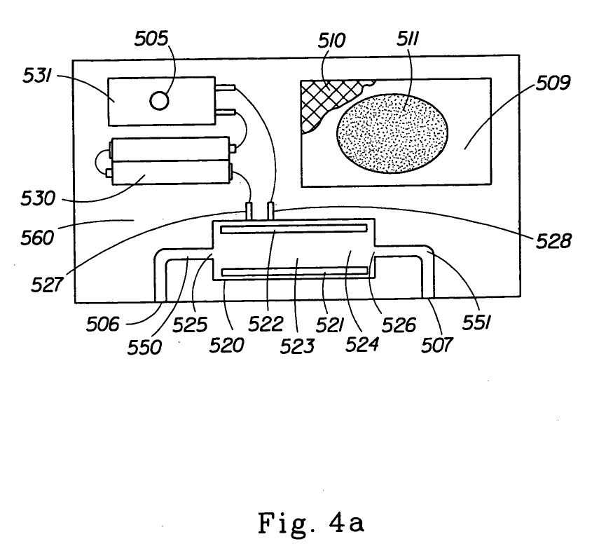

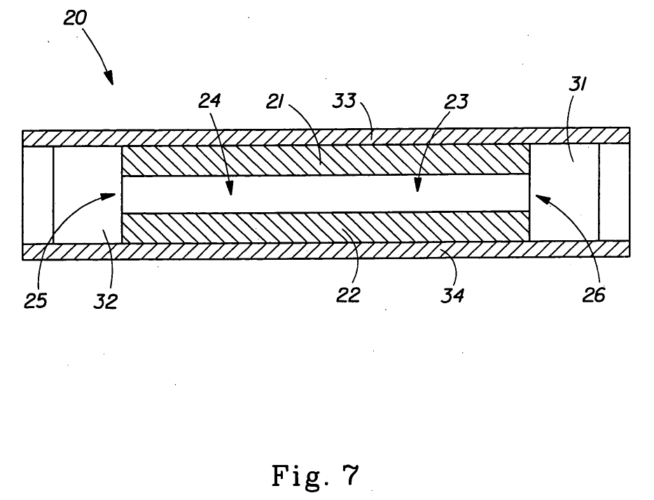

FIG. 4 and FIG. 4a depict another embodiment of the present invention. The electrolytic device, 500, can be located on any interior surface of the washing vessel, 213, of the automatic dishwashing appliance (not shown) itself. The electrolytic device, 500, respectively, having a body, 512, with a substantially continuous outer surface, 508. The body, 512, comprising an inlet port, 506, which can be covered by a detachable filter or screen (not shown), to minimize fouling of the electrochemical cell, due to the large debris load during the collection of electrolytic solution in the wash and/or rinse cycle of the automatic dishwashing appliance, an outlet port, 507, for discharge of the electrolyzed water to the washing vessel (not shown). The body, 512, can optionally comprise at least one additional compartment, 509. The compartment, 509, can house a product or local source of halogen ions, 511, which dissolves slowly (e.g. over months) when exposed to the wash and/or rinse liquor (not shown). The compartment, 509, comprising an easily removable and replaceable plastic screen, 510, which helps to contain the product, 511, in the compartment, 509, and also allows for fluid communication between the product, 511, and the wash and/or rinse liquor (not shown) during operation of the appliance (not shown). When the product, 511, can be completely dissolved, the consumer can add a product refill by removing the plastic screen, 510, and inserting a new product, 511, or refill in the compartment, 509, and then closing the screen, 510, to contain the new product, 511. All components shown in FIG. 7 and FIG. 7a are disposable and/or replaceable.

The electrochemical cell, 520, of FIG. 4a can be in fluid communication with the aqueous electrolytic solution, comprising the wash and/or rinse liquors from the appliance, via the inlet port, 506, of the body, 512. The inlet port, 506, can be outwardly connected to a funnel or water collection tray (not shown) to allow electrolytic solution comprising wash liquor, rinse liquor, tap water, and mixtures thereof, to be directed to an electrochemical cell, 520. The inlet port, 506, can be inwardly connected to a tube or duct, 550, which can be connected to an electrochemical cell, 520, having an inlet opening, 525, an anode electrode, 521, a cathode electrode, 522, defining a cell gap comprising a cell passage, 523, formed therebetween through which the aqueous electrolytic solution can flow, an outlet opening, 526, connected to a tube or duct, 551, which can be connected to the outlet port, 507, to allow the electrolyzed water (not shown) to discharge into the washing vessel (not shown) of the automatic dishwashing appliance (not shown).

The automatic dishwashing appliance can comprise a source of electrical current supply (not shown), which can be integrated into appliance itself. Besides having a source of electrical current supply (not shown), the attached, integrated electrochemical cell, 520, and/or electrolytic device, 300, can optionally have a supplemental battery, 530, which can provide the current used by the electrochemical cell, 520, to the anode lead, 527, and the cathode lead, 528, of the electrochemical cell, 520, to generate electrolyzed water in the cell passage, 524. The electrochemical cell, 520, can be optionally electrically and/or electronically connected to a controller, 531, which comprising an on-off switch (not shown), a timer/sensor (not shown), and an indicator lamp, 505, that indicates to the consumer the status of the appliance, the cell and/or the device during operation. The indicator can show the consumer that the electrolytic device, 500, the cell, 520, and/or the batteries, 530, needs to be replaced. The cathode lead, 552, can be connected to the controller, 531, which can be connected to the positive lead of the battery, 530, to the anode lead, 553, connected to the negative lead of the battery, 530.

The water collected by the inlet port, 506, can flow by gravity and/or by pump through the electrochemical cell, 520, and out the outlet port, 507, via a tube or duct, 551. The release or discharge of at least some electrolyzed water (not shown) as a discharge effluent via the outlet opening, 526, of the electrochemical cell, 520, itself and/or the outlet port, 507, of the electrolytic device, 500, into the appliance (not shown) can occur at specific timed intervals or continuously during operation of the wash and/or rinse cycles.

During operation, the electrochemical cell, 520, positioned inside the body, 512, can be placed into fluid communication with the aqueous electrolytic solution (not shown) of the automatic dishwashing appliance (not shown) comprising tap water, wash and/or rinse liquor, and mixtures thereof (not shown), via at least one inlet port, 506. The inlet port, 506, can be connected to a tube or duct, 550, that connects to the inlet opening, 525, of the electrochemical cell, 520. Likewise, the body, 512, can have an outlet port, 507, that can be in fluid communication between the outlet opening, 526, and with the wash and/or rinse liquor (not shown) of the automatic dishwashing appliance (not shown) via a tube or duct, 551.

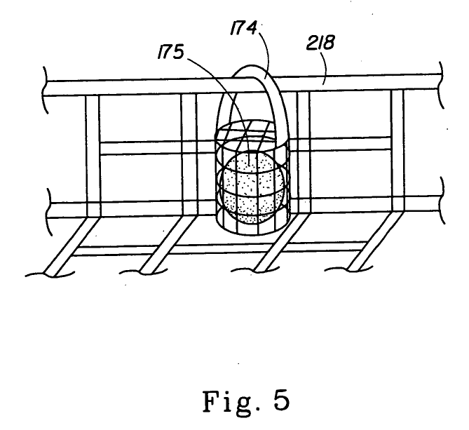

FIG. 5 depicts a porous basket, 174, for dispensing a product, 175, which can be placed in rack, 218, of any automatic dishwashing appliance of the present invention to deliver the product to the washing water, 248, of the appliance over time by slowly dissolving with each wash and/or rinse cycle.

Although the present invention has been described and illustrated in detail, it can be clearly understood that the same can be by way of illustration and example only and is not to be taken by way of limitation, the spirit and scope of the present invention being limited only by the terms of the appended claims.

FIG. 6 shows an embodiment of the unattached, non-partitioned electrochemical cell, 20, of the present invention. The electrochemical cell, 20, can comprise at least one pair of electrodes; an anode, 21, electrode, and a cathode, 22, electrode defining a cell gap, 23, comprising a cell passage, 24, formed therebetween through which the aqueous electrolytic solution can flow. The electrodes are held a fixed distance away from one another by at least one pair of opposed non-conductive electrode holders, 31, having electrode spacers, 29, that space apart the confronting longitudinal edges of the anode, 21, and cathode, 22 defines the cell gap, 23, comprising the cell passage, 24. The cell passage, 24, has an inlet opening, 25, through which the aqueous electrolytic solution can pass into of the electrochemical cell, 20, and an opposed outlet opening, 26, from which the effluent can pass out of the electrochemical cell, 20.

In one embodiment of the present invention, the inlet opening, 25, and outlet opening, 26, are in fluid communication with the aqueous electrolytic solution comprising the tap water, wash and/or rinse liquors, and mixtures thereof, thus allowing release, discharge, or propulsion of at least some electrolyzed water as a discharge effluent outside the cell and/or device, into the washing basin of the dishwashing appliance.

FIG. 7 shows the assembly of the anode, 21, and cathode, 22, and the opposed plate holders, 31, are held tightly together between a non-conductive anode cover, 33, (shown partially cut away), and cathode cover, 34, by a retaining means (not shown) that can comprise non-conductive, water-proof adhesive, bolts, or other means, thereby restricting exposure of the two electrodes only to the aqueous electrolytic solution that flows through the passage, 24. Anode lead, 27, and cathode lead, 28, extend laterally and sealably through channels made in the electrode holders, 31.

The gap, 23, between the at least one pair of electrodes has a gap spacing between about 0.1 mm to about 5.0 mm. The operating voltage that can be applied between the at least one pair of electrodes can be between about 1 and about 12 volts; preferably between about 3 volts and 6 volts. The electrochemical cell, 20, can be disposable and/or replaceable via a refill and/or a replacement cartridge (not shown) which can be removable from at least one sealed or sealable compartment, 14, of an automatic dishwashing appliance (not shown) containing an attached, integrated electrochemical cell (not shown) and/or electrolytic device (not shown).

The electrochemical cell, 20, can also comprise two or more anodes, 21, or two or more cathodes, 22. The anode, 21, and cathode, 22, plates are alternated so that the anode, 21, can be confronted by a cathode, 22, on each face, with a cell passage, 24, therebetween. Examples of electrochemical cells that can comprise a plurality of anodes and cathodes are disclosed in U.S. Pat. No. 5,534,120, issued to Ando et al. on Jul. 9, 1996, and U.S. Pat. No. 4,062,754, issued to Eibl on Dec. 13, 1977, which are incorporated herein by reference.

Generally, the electrochemical cell, 20, will have at least one or more inlet openings, 25, in fluid communication with each cell passage(s), 24, and at least one or more outlet openings, 26, in fluid communication with the cell passage(s), 24. The inlet opening, 25, can be also in fluid communication with the source of aqueous electrolytic solution, such that the aqueous electrolytic solution can flow into the inlet opening, 25, through the cell passage, 24, and from the outlet opening, 26, of the electrochemical cell, 20.

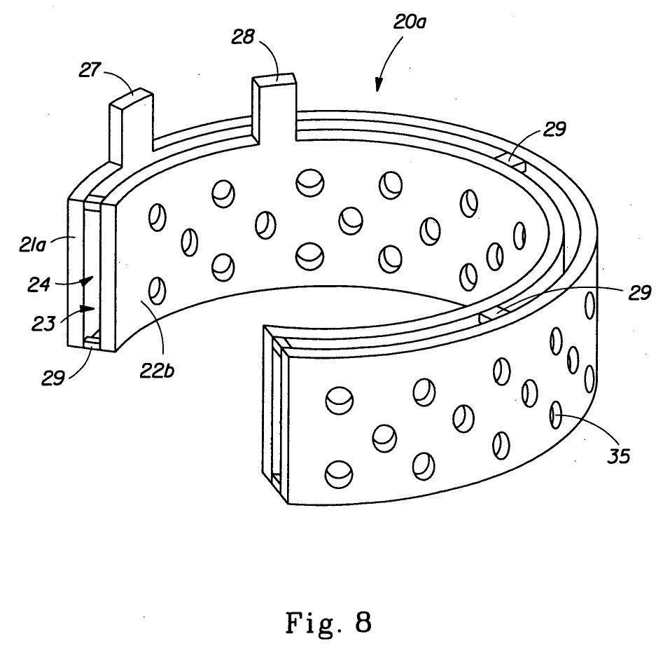

FIG. 8 depicts a porous, or flow-through electrode, 20a, comprising a porous cathode, 22a, and a porous anode, 21a. The porous anode, 21a, has a large surface area and large pore volume sufficient to pass there through a large volume of electrolytic solution. The plurality of pores, 35, and flow channels in the porous anode, 21a, provide a greatly increased surface area providing a plurality of passages, through which the aqueous electrolytic solution can pass.

The flow path of the aqueous electrolytic solution through a porous anode, 21a, should be sufficient, in terms of the exposure time of the solution to the surface of the anode, 21a, to convert the halogenated electrolytic solution containing salt to the halogenated mixed oxidants. The flow path can be selected to pass the aqueous electrolytic solution in parallel with the flow of electricity through the porous anode (in either the same direction or in the opposite direction to the flow of electricity), or in a cross direction with the flow of electricity. The porous anode, 21a, permits a larger portion of the aqueous electrolytic solution to pass through the passages adjacent to the anode surface, thereby increasing the proportion of the halogenated salt solution that can be converted to the halogenated mixed-oxidant species.

Automatic Dishwashing Appliance having a Recirculating Cell and/or Device

One embodiment of the present invention relates to an automatic dishwashing appliance containing a recirculating cell and/or device. The appliance can comprise an electrolytic composition comprising recirculated wash and/or rinse liquor, and wherein at least some of the recirculated wash and/or rinse liquor can be electrolyzed by the recirculating cell and/or device.

The aqueous electrolytic solution can comprise fresh tap water (i.e. incoming tap water supply), recirculated wash liquor, recirculated rinse liquor, and mixtures thereof. During the wash and/or rinse cycles, the pump in the automatic dishwashing appliance can continually circulate and re-circulate electrolytic solution comprising wash and/or rinse liquor from the appliance washing basin through the recirculating cell and/or device. The recirculating cell can comprise a cell passage having an inlet opening and an outlet opening. The inlet and outlet openings are in fluid communication with the aqueous electrolytic solution comprising the wash and/or rinse liquors thus allowing release, discharge, or propulsion of at least some electrolyzed water as a discharge effluent.

The recirculated, electrolytic solution present in the appliance can be continually available for electrolytic treatment during operation. In one embodiment, the discharge effluent being in fluid communication with the wash and/or rinse liquor can be discharged or released outside the recirculating cell and/or device through the outlet port into the washing basin of the dishwashing appliance by simply gravity flow. In another embodiment, the recirculating cell and/or device can further comprise a pumping means to propel the discharge effluent into the appliance through the outlet port. The recirculating pump can be located within a compartment of the body of the recirculating cell and/or device and/or in a separate compartment within the appliance, itself.

In time, the concentration of the un-reacted halogenated salt in the aqueous electrolytic solution can be reduced to a low level whereby the charged amount of the halogenated salt in the aqueous electrolytic solution will have been nearly completely converted to halogenated mixed oxidants.

One embodiment of the present invention relates to an automatic dishwashing appliance for treating tableware to provide an improvement in cleaning, sanitizing, and/or stain removal, the appliance comprising a source of electrical current supply, and a recirculating cell and/or device; wherein the recirculating cell comprising at least one inlet opening and one outlet opening, and at least one pair of electrodes defining at least one cell gap comprising at least one cell passage formed therebetween through which an aqueous electrolytic solution can flow. At least some of the aqueous electrolytic solution will recirculate through the recirculating cell and be discharged into the appliance as an electrolyzed discharge effluent. The recirculated electrolytic solution comprising at least some electrolyzed water from electrolysis of a water supply source selected from the group consisting of incoming tap water, recirculated wash and/or rinse liquors, and mixtures thereof.

In one embodiment of the present invention, the source of electrical current supply can be alternating current which can be drawn from the appliance's internal electric current or from the household electrical current from which the appliance draws its electrical current. The operating voltage of the recirculating cell and/or device can be between about 1.5 to about 12 volts. The source of electrical current supply can comprise at least one battery, at least one rechargeable battery, and mixtures thereof.

Another embodiment of the present invention relates to an appliance that allows for at least some wash and/or rinse liquor to: (a) continuously pass through the recirculating cell and/or device as a discharge effluent, (b) be bypassed back into the washing basin of the dishwashing appliance without undergoing electrolysis, and (c) combinations thereof; wherein when recirculating wash and/or rinse liquor can be discharged from the recirculating cell and/or device, the discharge effluent comprising at least some electrolyzed recirculated wash and/or rinse liquor.

Another embodiment of the present invention relates to an appliance further comprising a attached, integrated, non-recirculating electrochemical cell and/or electrolytic device comprising a non-recirculating electrochemical cell (hereinafter “non-recirculating cell and/or device”), wherein the non-recirculating cell and/or device does not allow for recirculation of wash and/or rinse liquor. Thus, the only water treated by the cell and/or device can be tap water from an incoming tap water supply. When tap water can be treated and discharged from the non-recirculating cell and/or device, the discharge effluent comprising at least some electrolyzed tap water.

Another embodiment of the present invention relates to an appliance wherein the recirculating cell can be a recirculating dual-purpose cell comprising both a recirculating portion and a non-recirculating portion. The dual-purpose cell can provide (a) electrolyzed, recirculated wash and/or rinse liquor from the recirculation portion, (b) electrolyzed, non-recirculated tap water from the non-recirculating portion, and (c) combinations thereof, at specific time intervals throughout the wash and/or rinse cycles of the appliance when activated. The recirculating dual-purpose cell can be disposable and/or replaceable, partitioned, non-partitioned, robust, energy-saving, and combinations thereof.

Another embodiment of the present invention relates to an appliance, wherein the recirculating cell and/or device can be non-partitioned, partitioned, and combinations thereof. The cell gap between the pair of electrodes can have a spacing between about 0.1 mm to about 5.0 mm. The pair of electrodes comprising at least one anode and at least one cathode, wherein all or part of the electrolyzed water can be split into two separate streams, an anode stream and a cathode stream, and wherein the split streams are optionally used separately at different times during the wash and/or rinse cycles of the appliance and for different purposes.

Another embodiment of the present invention relates to an appliance comprising a partitioned, recirculating cell and/or device, wherein the electrolyzed water from the anode stream of the partitioned cell can be used during one of the rinse cycles in the appliance. The recirculating cell and/or electrolytic device comprising a means for activating and/or deactivating the recirculating cell and/or device to enable and/or disable electrolysis at specific time intervals throughout the wash and/or rinse cycles of the appliance. The means of activation and/or deactivation of the recirculating cell and/or device comprising at least one sensor capable of analyzing and/or detecting a target composition of the fluid or gaseous environment within the appliance, recirculating cell, and/or device, and wherein when the sensor detects the target composition, the sensor provides an electric and/or electronic signal to the appliance, recirculating cell, and/or device, to activate and/or deactivate the recirculating cell and/or device. The target composition comprising a volatile compound or gas selected from the group consisting of perfumes, perfume raw materials, volatile organic compounds, inorganic gases, and mixtures thereof. The sensor can be selected from the group consisting of turbidity sensor, water hardness sensor, pH sensor, conductivity sensor, and mixtures thereof.

Another embodiment of the present invention relates to an appliance, wherein the recirculating cell can be robust, wherein the robust, recirculating cell comprising at least one cathode of stainless steel and at least one anode of titanium, and wherein the anode can be coated and/or layered with at least one of the materials selected from the group consisting of platinum, ruthenium iridium, and oxides, alloys, and mixtures thereof. The robust, recirculating cell can be partitioned and/or non-partitioned, having a cell gap between the pair of electrodes with a spacing between about 0.1 mm to about 0.5 mm.

Another embodiment of the present invention relates to an appliance, wherein the recirculating cell and/or device can further comprise a filtering means to minimize fouling of the cell passage from flow of the recirculated electrolytic solution through the cell passage. The filtering means comprising a disposable and/or replaceable filter that removes food particles and debris greater than about 0.1 mm, preferably greater than about 0.05 mm, most preferably greater than about 0.01 mm in size from the recirculating electrolytic solution prior to the solution entering the cell passage.

Another embodiment of the present invention relates to an appliance, wherein the appliance comprising a cycle setting using words selected from the group consisting of “economy”, “energy”, “anti”, “low”, “efficient”, “econo”, “regular”, “heavy duty”, “drying”, “sanitization”, “sanitizing”, “sanitary”, “antimicrobial”, “antibacterial”, “energy-savings”, “low-energy”, and mixtures thereof.

Another embodiment of the present invention relates to an appliance, further comprising a storage means for storing at least one product prior to its release. The storage means comprising at least one sealed or sealable compartment for housing and delivering the product to the wash and/or rinse liquor of the appliance, such that the product can be discharged in conjunction with at least one predetermined point in time during the wash and/or rinse cycle of the appliance. When the sealed or sealable compartment houses a product, the sealed or sealable compartment can be optionally recloseable such that the contents of the sealed or sealable compartment are not contaminated by an external medium.

Another embodiment of the present invention relates to an appliance, further comprising an autodosing system for delivery of the product. Another embodiment of the present invention relates to an appliance, comprising an interior stainless steel tub. Another embodiment of the present invention relates to an appliance, wherein the appliance comprising a drying cycle to remove moisture from the inside of the machine. The drying can be by air convection.

Another embodiment of the present invention relates to an appliance, wherein the recirculated electrolytic solution passes through the recirculating cell and/or device by gravity flow, by pumping, by mass transport, by gradient, and combinations thereof. The pump can be housed in the appliance and/or the device. Another embodiment of the present invention relates to an appliance, wherein the recirculated electrolytic solution passes through the recirculating cell and/or device by gravity flow. The recirculated electrolytic solution can be collected via a recirculated wash and/or rinse liquor collection tray located within any interior surfaces of the appliance itself. Another embodiment of the present invention relates to an appliance, wherein the appliance can further comprise a water softener.

Another embodiment of the present invention relates to an appliance, wherein the appliance can further comprise a means for communicating to the consumer when it can be time to refill and/or replace a component selected from the group consisting of a recirculating cell, recirculating dual-purpose cell, recirculating device comprising the recirculating cell, product refill and/or replacement cartridge, filter, elastomeric slit valve, porous basket comprising a product for dispensing, and combinations thereof.

Another embodiment of the present invention relates to an appliance, wherein the appliance and/or device can further comprise a disposable, replaceable, and/or self-contained source of halide salts having the formula (M)ₓ(XO₂)_{y} and/or (M)ₓ(X)_{y} wherein X can be Cl, Br, or I, wherein M can be a metal ion or cationic entity, and wherein x and y are chosen such that the salt can be charge balanced.

Another embodiment of the present invention relates to an appliance, wherein the appliance can be a commercial dishwasher selected from the group consisting of conveyor-low-temperature type, cabinet-low-temperature type, and combinations thereof.

Another embodiment of the present invention relates to method, wherein the recirculating cell and/or device can be self-cleaning via a source of tap water. For example, the steps could comprise opening valve, 271, in the dual-purpose cell, 265, and allowing the tap water to flow through cell passage, 275, via the inlet opening, 273, and discharged out the outlet port, 278, via the outlet opening, 276, and duct, 277, until substantially all food debris is removed from said passage, 275 (see FIGS. 5 and 5a). The self-cleaning step can be provided by any means wherein the cleaned recirculating cell is substantially free of food debris. The self-cleaning step can be activated by a sensor (not shown), a timer (not shown), and/or a controller (not shown). The self-cleaning step can provide for periodic or sequential self-cleaning of the recirculating cell before, during, and/or after a wash and/or rinse cycle of the appliance.

The following U.S. Patents disclose recirculation means and methods: U.S. Pat. No. 5,924,432; U.S. Pat. No. 5,868,937; U.S. Pat. No. 5,837,151; U.S. Pat. No. 4,392,891; U.S. Pat. No. 4,098,616; U.S. Pat. No. 3,698,407; and U.S. Pat. No. 3,807,419.

Energy-Saving Automatic Dishwashing Appliance having an Energy-Saving Cell and/or Device

Another embodiment of the present invention relates to an energy-saving appliance comprising a source of electrical current supply, and an attached, integrated, energy-saving cell and/or device; wherein the energy-saving cell can comprise at least one inlet opening and one outlet opening, and at least one pair of electrodes defining at least one cell gap comprising at least one cell passage formed therebetween through which an aqueous electrolytic solution can flow. The energy-saving appliance has a total energy consumption of less than about 1.8 kWh per complete operating cycle and/or less than about 600 kWh per year, preferably less than about 1.7 kWh per operating cycle and/or about 555 kWh per year, most preferably less than about 1.2 kWh per operating cycle and/or about 400 kWh per year, The total energy consumption of the appliance includes any energy used to heat wash and/or rinse liquor in the appliance.

Another embodiment of the present invention relates to an energy-saving appliance further comprising an incoming tap water supply comprising at least a cold water supply. The incoming tap water supply can also consist essentially of a cold water supply. A water-heating booster, a water-heating element, and/or other means of providing additional thermal energy to the incoming tap water supply are optional, and not required for the sanitization of tableware. The energy-saving cell of the present invention can be selected from the group consisting of partitioned, non-partitioned, robust, recirculating, non-recirculating, and combinations thereof.

Another embodiment of the present invention relates to an energy-saving appliance further comprising a storage means for storing at least one product prior to its release. The storage means comprising at least one sealed or sealable compartment for housing and delivering the product to the wash and/or rinse liquor of the appliance, such that the product can be discharged in conjunction with at least one predetermined point in time during the wash and/or rinse cycle of the appliance, wherein when the sealed or sealable compartment houses the product the sealed or sealable compartment can be optionally recloseable such that the contents of the sealed or sealable compartment are not contaminated by an external medium.

Another embodiment of the present invention relates to an energy-saving appliance further comprising a means for communicating to the consumer when it can be time to refill and/or replace a component selected from the group consisting of an energy-saving cell, energy-saving dual-purpose cell, energy-saving device comprising the energy-saving cell, energy-saving dual-purpose cell, product refill and/or replacement cartridge, filter, elastomeric slit valve, porous basket comprising a product for dispensing, and combinations thereof.

Automatic Dishwashing Appliance containing a Disposable Cell and/or Device

Another embodiment of the present invention relates to an automatic dishwashing appliance comprising a source of electrical current supply, and a disposable cell and/or device. The disposable cell can comprise at least one inlet opening and one outlet opening, and at least one pair of electrodes defining at least one cell gap comprising at least one cell passage formed therebetween through which an aqueous electrolytic solution can flow. When the disposable cell becomes fouled, the disposable cell can be removed from the appliance and/or device and be replaced, as needed.

Another embodiment of the present invention relates to an appliance, further comprising a storage means for storing at least one product prior to its release. The storage means comprising at least one sealed or sealable compartment for housing and delivering the product to the wash and/or rinse liquor of the appliance, such that the product can be discharged in conjunction with at least one predetermined point in time during the wash and/or rinse cycle of the appliance, wherein when the sealed or sealable compartment houses the product the sealed or sealable compartment can be optionally recloseable such that the contents of the sealed or sealable compartment are not contaminated by an external medium.

Another embodiment of the present invention relates to an appliance, wherein the disposable cell can be selected from the group consisting of partitioned, non-partitioned, robust, energy-saving, recirculating, non-recirculating, and combinations thereof.

Another embodiment of the present invention relates to an appliance, wherein the appliance can further comprise a disposable and/or replaceable component selected from the group consisting of cell, recirculating cell, dual-purpose cell, device which comprises an electrochemical cell and/or dual-purpose cell, product refill and/or replacement cartridge, filter, elastomeric slit valve, porous basket comprising a product for dispensing, and combinations thereof.

Another embodiment of the present invention relates to an appliance, wherein the appliance can further comprise a means for communicating to the consumer when it can be time to refill and/or replace a disposable and/or replaceable component described herein. The communication means can comprise an indicator, sensor, timer, controller, CPU, and/or combinations thereof.

Another embodiment of the present invention relates to an appliance, wherein the appliance and/or device can further comprise at least one sealed or sealable compartment, and wherein all or part of the disposable cell can be removable from the appliance and/or device via the sealed or sealable compartment. The cell regeneration means can extend the operating life of the pair of electrodes in the disposable cell and/or device by descaling and/or unfouling the pair of electrodes. The cell regeneration means can comprise a means for periodically reversing the polarity of the pair of electrodes, and/or a means for the addition of a liquid electrode cleansing composition into an aperture in fluid communication with the inlet opening of the disposable cell and/or optional inlet port of the electrolytic device which comprises an electrochemical cell in order to descale and/or unfoul the pair of electrodes of the disposable cell and/or device. The regeneration means can optionally comprise an aperture greater than 0.5 mm in diameter, wherein the aperture can be located within the door of the appliance.

Another embodiment of the present invention relates to an appliance, wherein the disposable cell and/or device can be easily removable and/or replaceable, and optionally comprising an aperture greater than 0.5 mm in diameter in fluid communication with the pair of electrodes of the disposable cell and/or device; wherein the aperture allows for periodic addition of the liquid electrode cleansing composition. The electrode cleansing composition can comprise an anticorrosion or descaling agent, such as, vinegar.

Another embodiment of the present invention relates to a method of maintaining an appliance comprising an removable, disposable, and/or replaceable cell and/or device, the method comprising the steps of: (a) removing the disposable cell and/or device; (b) placing the liquid electrode cleansing composition in fluid communication with the pair of electrodes of the removed disposable cell and/or device for an effective duration of time to allow for electrode descaling or defouling to occur; and (c) placing the cleaned, disposable cell and/or device back into the appliance for reuse.

Electrolytic Solution

The components of the aqueous electrolytic solution can be selected from the group consisting of chloride ions, chlorite ions, water-soluble salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, electrolysis precursor compounds, electrolysis salts with low water solubility, electrolysis precursor compounds contained within a medium or matrix for controlled release, and mixtures thereof.

Preferred electrolytic solutions contain at least some halogen ions, including but not limited to chloride, chlorite, bromide, bromite, iodide, and iodite, and mixtures thereof; preferably chloride ions or chlorite ions. Of course, electrolytic solutions containing higher levels of halogen ions are more efficiently converted into a discharge effluent solution having even larger amounts of the mixed oxidants. This can be due in part because the conductivity of the aqueous electrolytic solution increases with the concentration of halogen ions, thereby enabling a greater current flow across the passage gap between the pair of electrodes under a constant voltage potential. In general, to produce the same amount of mixed oxidants at a fixed power (current and voltage potential), an aqueous electrolytic solution having a higher concentration of halogen ions allows substantially smaller gap spacing, compared to an aqueous electrolytic solution having lower concentrations of the halogen ions.

Preferably the aqueous electrolytic solution has a specific conductivity p of greater than 100 μS/cm, preferably more than 150 μS/cm, even more preferably more than 250 μS/cm, and most preferably more than 500 μS/cm.

Discharge Effluent

The discharge effluent (the electrolyzed aqueous electrolytic solution that exits from the electrochemical cell) can comprise an effective amount of halogenated mixed oxidants that was converted within the cell passage in response to the flow of electrical current through the aqueous electrolytic solution. The discharge effluent can be used for cleaning, sanitizing, and/or stain removal (e.g. bleaching) of tableware. The effluent can itself be a treated solution, where the aqueous electrolytic solution contains microorganisms or some other oxidizable source material that can be oxidized in situ by the halogenated mixed oxidants that can be formed.

The discharged effluent containing the electrolyzed halogenated mixed oxidants can be removed from the electrochemical cell and can be used, for example, as an aqueous sanitization or an aqueous bleaching solution. The effluent can be used as-made by direct delivery to an oxidizable source. The oxidizable source can be a second source of water or other aqueous solution comprising microorganisms, which are destroyed when mixed or contacted with the effluent solution. Microorganisms present on the tableware or within the aqueous electrolytic solution would also be destroyed. The oxidizable source can also be an article or object on which oxidizable material can be affixed or positioned, such as a dishware, tableware, as well as, stains on the inside surfaces of an automatic dishwashing appliance.

The concentrated effluent containing a high concentration of halogenated mixed oxidants can be maintained by electrolyzing recirculated wash and/or rinse liquor throughout the wash and/or rinse cycle(s) of the automatic dishwashing appliance, or as needed.

When halogenated mixed oxidants oxidize an oxidizable material, such as a microorganism or a bleachable stain on tableware, the halogenated mixed oxidants revert back to a lower oxidation state, such as sodium chloride, sodium chlorite, and the like. Because the method and appliance of the present invention can convert a halogen into halogenated mixed oxidants in simple, non-partitioned, electrochemical cells, a preferred system for forming halogenated mixed oxidants from an aqueous electrolytic solution can comprise a means for returning the reverted halogen salts back to the aqueous electrolytic solution, for subsequent re-conversion to halogenated mixed oxidants. This can be accomplished by recirculation of the wash and/or rinse liquor as discharge effluent which can exit the cell and/or device by means of a pump, gravity, mass transport, gradient, and combinations thereof.

Product

The product described in this invention can comprise a component selected from the group consisting of suds suppressor, perfume, a bleach-scavenging agent, a metal-protecting agent, and optionally, a component selected from the group comprising electrolytic solution containing chloride ions, chlorite ions, electrolytic solution containing salts having the formula (M)ₓ(XO₂)_{y} and/or (M)ₓ(X)_{y} wherein X can be Cl, Br, or I, wherein M can be a metal ion or cationic entity, and wherein x and y are chosen such that the salt can be charge balanced, electrolysis precursor compounds, electrolysis salts with low water solubility, electrolysis precursor compounds contained within a medium for controlled release, electrolyzed water, detergent compositions, rinse aid compositions, electrode cleaning agents, bleach-scavenging agents, metal-protecting agents, adjunct ingredients, and mixtures thereof. The bleach-scavenging agent and/or metal-protecting agent can be selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof.

The product can be in the form selected from the group consisting of a tablet, pellet, particle, prill, powder, gel, liquid, and combinations thereof. The product can exist in direct fluid communication and/or contact with wash and/or rinse liquors, tap water, electrolytic solution, and combinations thereof, for at least some period of time during operation of the appliance rather contained within a sealed or sealable compartment located within the appliance, the cell, the device, and combinations thereof.

When the electrolysis can be no longer desired, the product can comprise a bleach-scavenging agent or a metal-protecting agent to inhibit the activity of the halogenated mixed oxidants. Bleach-scavenging agents or metal-protecting agents can be selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof.

Porous Basket comprising Product for Dispensing

The porous basket for dispensing a product can be placed in rack of any automatic dishwashing appliance of the present invention. The porous basket comprising product described above can be similar to the article of manufacture, provided by Benckiser, Inc., Toronto, Canada, sold as Jet-Dry® Sparkle which can be a solid rinse agent that dissolves slowly in the rack of an automatic dishwashing appliance during operation.

Another embodiment of the present invention relates to an appliance, wherein the appliance and/or device can further comprise a disposable, replaceable, and/or self-contained product comprising a source of halide salts having the formula (M)ₓ(XO₂)_{y} and/or (M)ₓ(X)_{y} wherein X can be Cl, Br, or I, wherein M can be a metal ion or cationic entity, and wherein x and y are chosen such that the salt can be charge balanced.

Electrodes

An electrode of the present invention can generally have any shape that can effectively conduct electricity through the aqueous electrolytic solution between itself and another electrode, and can include, but is not limited to, a planar electrode, an annular electrode, a spring-type electrode, and a porous electrode. The anode and cathode electrodes can be shaped and positioned to provide a substantially uniform gap between a cathode and an anode electrode pair. On the other hand, the anode and the cathode can have different shapes, different dimensions, and can be positioned apart from one another non-uniformly. The important relationship between the anode and the cathode can be for a sufficient flow of current through the anode at an appropriate voltage to promote the conversion of the halogenated salt solution to halogenated mixed-oxidant species within the cell passage adjacent the anode.

Planar electrodes, such as shown in FIG. 6, have a length along the flow path of the solution, and a width oriented transverse to the flow path. The aspect ratio of planar electrodes, defined by the ratio of the length to the width, can be generally between 0.2 and 10, more preferably between 0.1 and 6, and most preferably between 2 and 4.

Another embodiment of the present invention relates to an automatic dishwashing appliance containing a robust cell and/or device. The robust cell being non-partitioned can be less prone to fouling. The robust cell can comprise a cathode of stainless steel and an anode of titanium. The anode can be coated and/or layered with at least one of the materials selected from the group consisting of platinum, ruthenium iridium, and oxides, alloys, and mixtures thereof. The cell passage of the robust cell forms a gap between the at least one pair of electrodes having a gap spacing between about 0.1 mm to about 0.5 mm; and wherein the operating voltage can be between about 3 and about 6 volts.

Porous media useful in the present invention are commercially available from Astro Met Inc. in Cincinnati, Ohio, Porvair Inc. in Henderson, N.C., or Mott Metallurgical in Farmington, Conn. Alternately U.S. Pat. Nos. 5,447,774 and 5,937,641 give suitable examples of porous media processing. Preferably, the porous anode, 21a, has a ratio of surface area (in square centimeters) to total volume (in cubic centimeters) of more than about 5 cm⁻¹, more preferably of more than about 10 cm⁻¹, even more preferably more than about 50 cm⁻¹, and most preferably of more than about 200 cm⁻¹. Preferably the porous anode, 21a, has a porosity of at least about 10%, more preferably of about 30% to about 98%, and most preferably of about 40% to about 70%. Preferably, the porous anode has a combination of high surface area and electrical conductivity across the entire volume of the anode, to optimize the solution flow rate through the anode, and the conversion of halogenated salt solution contained in the solution to the halogenated mixed-oxidant species.

One embodiment of the present invention relates to an automatic dishwashing appliance containing a cell and/or device, the cell comprising porous electrode, wherein the electrochemical cell having a cell gap between the at least one pair of electrodes having a gap spacing between about 0.1 mm to about 5.0 mm; wherein porous electrodes have a porosity of at least about 10%; and wherein the operating voltage can be between about 1 and about 12 volts.

The electrodes are commonly metallic, conductive materials, though non-metallic conducting materials, such as carbon, can also be used. The materials of the anode and the cathode can be the same, but can advantageously be different. To minimize corrosion, chemical resistant metals are preferably used. Examples of suitable electrodes are disclosed in U.S. Pat. No. 3,632,498 and U.S. Pat. No. 3,771,385. Preferred anode metals are stainless steel, platinum, palladium, iridium, ruthenium, as well as iron, nickel and chromium, and alloys and metal oxides thereof. More preferred are electrodes made of a valve metal such as titanium, tantalum, aluminum, zirconium, tungsten or alloys thereof, which are coated or layered with a Group VIII metal that can be preferably selected from platinum, iridium, and ruthenium, and oxides and alloys thereof. One preferred anode can be made of titanium core and coated with, or layered with, ruthenium, ruthenium oxide, iridium, iridium oxide, and mixtures thereof, having a thickness of at least 0.1 micron, preferably at least 0.3 micron.

For many applications, a metal foil having a thickness of about 0.03 mm to about 0.3 mm can be used. Foil electrodes should be made stable in the electrochemical cell so that they do not warp or flex in response to the flow of liquids through the passage that can interfere with proper electrolysis operation. The use of foil electrodes can be particularly advantageous when the cost of cell and/or device should be minimized, or when the lifespan of the electrolysis device can be expected or intended to be short, generally about one year or less. Foil electrodes can be made of any of the metals described above, and are preferably attached as a laminate to a less expensive electrically-conductive base metal, such as tantalum, stainless steel, and others.

The following references are also related to electrodes: U.S. Pat. No. 3,616,355; U.S. Pat. No. 4,048,047; U.S. Pat. No. 4,062,754; U.S. Pat. No. 4,100,052; U.S. Pat. No. 4,328,084; U.S. Pat. No. 4,761,208; U.S. Pat. No. 5,314,589; U.S. Pat. No. 5,395,492; U.S. Pat. No. 5,439,576; U.S. Pat. No. 5,954,939 (equiv. EP 711,730); and WO 00/34184.

Electrical Current Supply

The electrical current supply in one embodiment of the present invention can be a rectifier of household (or industrial) current that converts common 100-230 volt AC current to DC current. Another alternative can be a solar cell that can convert (and store) solar power into electrical power. Solar-powered photovoltaic panels can be used advantageously when the power requirements of the electrochemical cell draws currents below 2000 milliamps across voltage potentials between 1.5 and 9 volts.

Another embodiment of the present invention relates to an automatic dishwashing appliance comprising a source of electrical current supply, wherein the current can be supplied by one or more electrical batteries. The electrical battery can be preferably rechargeable. The batteries can be provided in a separate compartment within the appliance, such as, located on the exterior surface of the appliance door. In the alternative, the cell and/or device itself can further comprise at least one sealed or sealable compartment wherein a battery can be integrated within the cell and/or device via the at least one sealed or sealable compartment.

An electrical current supply provides a flow of electrical current between the electrodes and across the passage of aqueous feed solution passing across the anode.

One embodiment of the present invention can be an automatic dishwashing appliance containing a cell and/or device, the electrochemical cell comprising an electrochemical cell that can use the current and voltage delivered by conventional household batteries. An electrical current supply comprising a battery or set of batteries, preferably selected from an alkaline, lithium, silver oxide, manganese oxide, or carbon zinc battery. The batteries can have a nominal voltage potential of 1.5 volts, 3 volts, 4.5 volts, 6 volts, or any other voltage that meets the power requirements of the electrolysis device. Most preferred are common-type batteries such as “AA” size, “AAA” size, “C” size, and “D” size batteries having a voltage potential of 1.5 V. Two or more batteries can be wired in series (to add their voltage potentials) or in parallel (to add their current capacities), or both (to increase both the potential and the current). Re-chargeable batteries and mechanical wound-spring devices can also be advantageously employed and can be integrated within the appliance or body of the attached device via at least one sealed or sealable compartment. The electrochemical cells can come in various sizes, with anodes having a surface area of from about 0.1 cm² to about 60 cm².

In one embodiment, the electrochemical cell can comprise at least one single pair of electrodes having the anode connected to the positive lead and the cathode connected to the negative lead of the battery or batteries. A series of two or more electrodes, or two or more cells (each a pair of electrodes) can be wired to the electrical current source. Arranging the electrochemical cells in parallel, by connecting each cell anode to the positive terminal(s) and each cell cathode to the negative terminal(s), provides the same electrical potential (voltage) across each cell, and divides (evenly or unevenly) the total current between the two or more electrode pairs. Arranging two cells (for example) in series, by connecting the first cell anode to the positive terminal, the first cell cathode to the second cell anode, and the second cell cathode to the negative terminal, provides the same electrical current across each cell, and divides the total voltage potential (evenly or unevenly) between the two cells.

The electrical current supply can further comprise a circuit for periodically reversing the output polarity of the electrical current supply, battery and/or batteries in order to maintain a high level of electrical efficacy over time. The polarity reversal minimizes or prevents the deposit of scale and the plating of any charged chemical species onto the electrode surfaces. Polarity reversal functions particularly well when using confronting anode and cathode electrodes.

Operation of the Cell and/or Device

The chemistry of the conversion of halogen ions to halogenated mixed oxidants proceeds as electrical energy can be applied between the pair of electrodes and through the aqueous electrolytic solution. Since chloride can be the most prevalent halogen available, the description of the electrochemical cell chemistry and operation will be described with respect to converting chloride to chlorine, although it should be understood that other halides or halites, especially bromide, iodide, chlorite, bromite, and iodite would function and respond similarly to chloride. Similarly, since chlorinated tap water can be a useful electrolytic solution, the description below will describe the use of water having a residual amount of chloride ions, although it should be understood that other electrolytic solutions can be used, preferably those consisting of chloride ions, chlorite ions, water-soluble salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, electrolysis precursor compounds, electrolysis salts with low water solubility, electrolysis precursor compounds contained within a medium or matrix for controlled release, and mixtures thereof.

Water containing residual amounts of chloride ions can be electrolyzed as it passes between the anode (the positively charged electrode of the pair) and the cathode (the negatively charged electrode). Two of the reactions that occur at the anode electrode are set forth below as equations 1 and 2.
2Cl⁻→Cl₂+2e⁻ (1)
H2O→1/2O₂+2H⁺+2e⁻ (2)

One of the reactions that occurs at the cathode can be set forth as equation 3.
2H₂O+2e−→H₂+2OH⁻ (3)

Furthermore, chlorine molecules can be converted to hypochlorous acid and hypochlorite ions as set forth in equations 4 and 5, respectively.
Cl₂+H₂O→HOCl+Cl⁻+H⁺ (4)
HOCl→OCl⁻+H⁺ (5)

The chlorine gas that can be generated dissolves or diffuses into the water to generate free chlorine in the form of hypochlorous acid, hypochlorous acid ions, and hypochlorite ions. It can be believed that other various halogenated mixed oxidants that can form include chlorine dioxide (ClO₂), other chloro-oxides molecules, oxide molecules including ozone, hydrogen oxide (H₂O₂) and free radicals (oxygen singlet, hydroxyl radicals) and ions thereof. Such halogenated mixed oxidants are demonstrated and described in U.S. Pat. No. 3,616,355 and U.S. Pat. No. 4,761,208. These types of halogenated mixed oxidants are very effective biocidal agents, but have very short lifespans, lasting from a fraction of a second to minutes under ordinary, ambient conditions. Consequently, generating these biocidal agents at the point of use ensures the most effective use of the biocidal species, such as when generating the biocidal agents at specific time intervals throughout the wash and/or rinse cycles of the operation of the appliance and/or continuously without regard to sequencing.

For effective sanitizing treatment of tableware in contact with the aqueous electrolytic solution, the concentration of halogenated mixed oxidants in the electrochemical cell effluent, as measured by the DPD method, can be at least about 0.1 mg per liter (about 0.1 ppm) of electrochemical cell effluent, preferably 0.2 mg per liter (about 0.2 ppm), more preferably at least 1 mg per liter (about 1 ppm), and most preferably at least 5 mg per liter (about 5 ppm).

An important consideration can be the productivity of the electrical power of the electrochemical cell. When battery power can be used, it can be important to provide the greatest possible production of halogenated mixed oxidants for each watt of power consumed. This ensures long battery life, greater consumer convenience, smaller and more efficient electrochemical cells, and greater consumer value.

The productivity of an electrochemical cell can be expressed by equation I,
η=(CCl)(Q)/(I)(V) (I)
wherein:
η units are micrograms of chlorine per minute, per watt of power used;
CCl can be the concentration of the generated chlorine equivalent, as determined by the DPD Method, in milligrams per liter (mg/l);
I can be the electric current in amps;
Q can be the volumetric flow rate in milliliters per minute (ml/m); and
V can be electric potential across the electrochemical cell in volts.

The productivity η of the electroytic device used in accordance with the present invention can be typically greater than 100, and more typically greater than 250. In preferred embodiments of the electrochemical cell, the productivity η can be more than about 500, and more preferably more than about 1000, when the aqueous electrolytic solution has a concentration of halogen ions of more than 0.001% (10 ppm) and less than about 0.1%. Preferably, the cell and/or device has the above-described efficiencies when the electric current can be between about 100 milliamps and about 2000 milliamps, with typical current densities of between about 5 milliamps/cm² and 100 milliamps/cm² of exposed anode electrode surface, and more preferably between about 10 milliamps and 50 milliamps/cm². Since the electrical potentials required to convert chloride to chlorine can be about 1.36V, a voltage potential greater than 1.36V across the passage will generate a proportionally greater amount of halogenated mixed oxidants from the chloride ions. The voltage potential maintained between any pair of anode and cathode electrodes should be generally greater than 1.36V, and generally less than about 12 volts, and can be preferably between about 2.0V and 6V, and more preferably between about 3V and 4.5V. For self-powered self-contained devices, batteries are the preferred electrical current sources. To achieve the extended life from a set of batteries, cell and/or device can be preferably designed to draw a total power of 20 watts or less, preferably 5 watts or less, more preferably 2.5 watts or less, and most preferably 1 watt or less, across the electrode pairs of the electrochemical cell.

Generally, the electrochemical cell has a cell gap spacing greater than about 0.05 mm, preferably greater than 0.10 mm, more preferably greater than 0.15 mm, and most preferably greater than about 0.20 mm, and a cell gap spacing less than about 5 mm, preferably less than about 2.0 mm, more preferably less than about 0.80 mm, and most preferably less than about 0.50 mm. The more preferable cell gap spacings are for use with electrolytic solutions that contain a concentration of halide ions of less than about 200 ppm, and a specific conductivity ρ of greater than about 250 μS/cm.

The residence time between the inlet and outlet of the anode and cathode pair can be generally less than about 10 seconds and preferably can be less than about 5 seconds, in more preferred embodiments, between about 0.01 seconds and about 1.5 seconds, and most preferably between 0.05 and about 0.5 seconds. The residence time can be approximated by dividing the total volume of the passage between the anode and cathode pair by the average flow rate of water through the electrochemical cell.

Operation and effectiveness of the cell and/or device requires that the aqueous electrolytic solution passes through the electrochemical cell in a quantity sufficient to generate an effective production of the halogenated mixed oxidants for the intended purpose. In general, without some means of moving the aqueous electrolytic solution through the electrochemical cell, as opposed to simply filling the electrochemical cell, low levels of the halogenated mixed oxidants will be produced. Electrolytic solution comprising wash and/or rinse liquor can be moved through the cell and/or device by pumping through the electrochemical cell via an internal and/or external pumping means. Alternatively, cell and/or device can be placed into an area of the appliance washing basin where there can be water flow sufficient to pass through the electrochemical cell by gravity flow.

Feed Means

The means for passing the aqueous electrolytic solution (herein after, “feed means”) into the electrochemical cell can be a pump, or an arrangement where gravity or pressure forces aqueous electrolytic solution into the electrochemical cell. The means for delivering the aqueous effluent into contact with the halogen depletion target can be the feed means, or can be a separate pump or gravity/pressure arrangement.

The system can also comprise a re-circulation line through which at least some of the effluent solution can be returned back to the inlet of the electrochemical cell. As herein before described, re-circulating the effluent back to the electrochemical cell increases the total conversion of the halogenated salt solution to the halogenated mixed oxidants.

The means for returning the depleted effluent can be a collection tank with a means, such as any of the feed means, for recycling the depleted effluent back to the source.

The following U.S. Patents disclose feed means, pumps and methods:: U.S. Pat. No. 6,182,674; U.S. Pat. No. 5,909,743; U.S. Pat. No. 5,848,601; U.S. Pat. No. 5,711,325; U.S. Pat. No. 5,803,100; U.S. Pat. No. 5,450,868; U.S. Pat. No. 5,377,707; U.S. Pat. No. 5,143,513; and U.S. Pat. No. 4,753,570.

Pumping Means

The recirculating cell and/or device can be provided with a pump for pumping the aqueous electrolytic solution through the cell passage. The pump can provide two functions: (1) to move electrolytic solution from the automatic dishwashing appliance washing basin through the electrochemical cell, where halogenated mixed oxidants can be generated from halogen ions when electric current can be passed through the electrochemical cell; and (2) to expel and disperse the discharge effluent solution, containing the halogenated mixed oxidants, back into the automatic dishwashing appliance washing basin for subsequent treatment of tableware.

A preferred pumping means can comprise a pump having a rotating impeller. The pump inlet port can be in fluid communication with the aqueous electrolytic solution comprising wash and/or rinse liquor. The pump outlet port is in fluid communication with the inlet of the cell. The pump can be housed in a separate compartment within appliance, recirculating cell and/or device. Self-priming pumps, such as peristalsis pumps, can be used. The pump can be driven by an electric, direct drive motor that can be powered by any source of electric current supply, although other power means to drive the pump, such as mechanical wind-up springs or photovoltaic panels can be used. The pump electric motor can draw power of the same voltage potential as the electrochemical cell. The discharge effluent can be released, discharged or propelled outside the recirculating cell and/or device through the outlet opening of the cell and/or the outlet port of the device by means of a pump.

The pump can have a throughput of between 0.05 liters solution per minute, up to about 10 liters per minute. Higher pumping rates are possible, depending upon the size of the recirculating cell and/or device, and the capacity of any electric current supply. For recirculating cell and/or devices that are powered by conventional alkaline batteries, a preferred pumping capacity can be between 0.1 and 5 liters per minute, and more preferably between 0.2 and 2 liters per minute.

Alternatively, an automatic dishwashing appliance containing a recirculating cell and/or device can comprise a pumping means which discharges through the electrochemical cell, with at least some of the discharged effluent from the electrochemical cell being recirculated back to the inlet of the pump, to provide a continuous recycle of at least some of the effluent back through the inlet of the electrochemical cell. This arrangement can increase the concentration of the resulting mixed oxides in the effluent discharged from the electrochemical cell.

The following U.S. Patents disclose pumping means and regeneration methods: U.S. Pat. No. 6,182,674; U.S. Pat. No. 5,909,743; U.S. Pat. No. 5,848,601; U.S. Pat. No. 5,711,325; U.S. Pat. No. 5,803,100; U.S. Pat. No. 5,450,868; U.S. Pat. No. 5,377,707; U.S. Pat. No. 5,143,513; U.S. Pat. No. 4,753,570.

Means for Activating and/or Deactivating the Electrochemical Cell

At specific time intervals throughout the wash and/or rinse cycles of the appliance, the cell and/or device comprising at least one timer capable of turning cell and/or device on or off so as to result in optimal performance, for example to turn cell and/or device on during the middle or near the end of the wash cycle, or during one of more of the rinse cycles.

In addition, the cell and/or device can comprise at least one sensor capable of analyzing or detecting the composition of the fluid or gaseous environment of the cell, device and/or within the appliance itself. The sensor can be capable of detecting volatile compounds or gases selected from the group consisting of perfumes, perfume raw materials, volatile organic compounds, gases comprising oxides of carbon, sulfur, or nitrogen, and mixtures thereof. The sensor can also be capable of signaling the appliance, cell, and/or device in order to activate or deactivate the operation of the cell and corresponding production of halogenated mixed oxidants. When an electric signal can be sent from the sensor, the cell and/or device will activate or deactivate the production of halogenated mixed oxidants. The operation of the cell can be activated or deactivated at any specific time during the operation of the appliance, during a specific cycle (such as during the wash and/or rinse cycle), or for any other need identified by the consumer.

The following U.S. Patents disclose sensors, sensing devices and methods of use: U.S. Pat. No. 5,037,615, U.S. Pat. No. 5,308,771, U.S. Pat. No. 6,051,437, U.S. Pat. No. 6,077,712, U.S. Pat. No. 6,214,203, and U.S. Pat. No. 6,331,244.

Filtering Means

In order to minimize particulate fouling of the electrochemical cell from the flow of recirculated electrolytic solution comprising large particles through the cell passage, a filter, can be used. The filter can be made disposable and/or replaceable via a product refill and/or replacement cartridge. The filter can be removably housed in or attached to the inlet port of the appliance wall, the inlet port of the device, and/or the inlet opening of the cell, or by any other means such that the filter prevents particles greater than 0.1 mm from entering the cell and thereby ultimately preventing production of new halogenated mixed oxidants.

The shape or form of the filter will not be described as it can take on any shape or form. The filter itself can be comprised of any number available materials generally used in the art. These include, but are not limited to, plastic, metal, wire mesh, cloth, paper, and composites. The filter housing containing the actual filter can be made of plastic, metal, cloth, paper, and composites.

Another embodiment of the present invention relates to an automatic dishwashing appliance containing a cell and/or device, the electrochemical cell comprising a filtering means to minimize fouling of the cell from the flow of the recirculated electrolytic solution through the cell passage. The filtering means can comprise a filter removably housed in or attached to the inlet port of the appliance wall, the inlet port of the device, and/or the inlet opening of the cell. The filter can be disposable and/or replaceable.

The following U.S. Patents disclose filters, filtering devices, and methods of use: U.S. Pat. No. 6,234,184; U.S. Pat. No. 6,182,674; U.S. Pat. No. 5,909,743; U.S. Pat. No. 5,345,957; U.S. Pat. No. 4,038,103; U.S. Pat. No. 5,711,326; U.S. Pat. No. 5,601,660; U.S. Pat. No. 4,998,548; U.S. Pat. No. 4,468,333; and U.S. Pat. No. 3,575,185.

Regeneration Means

Electrochemical cell regeneration can be required to extend the operating life of the at least one pair of electrodes of the present invention when the electrodes are impacted by an electrolytic composition comprising hard water, large particulates and/or debris, or other contaminants that are capable of reducing the efficiency of the process of electrolysis of water within the attached, integrated electrochemical cell and/or electrochemical cell and/or electrolytic device. In order to produce effective levels of halogenated mixed oxidants, periodic or continuous addition of an electrode cleansing composition through the electrochemical cell passage can be required to maintain adequate electrical efficacy of the electrodes over time and corresponding satisfactory operation of the electrochemical cell itself.

The electrochemical cell regeneration means can comprise a liquid electrode cleansing composition, which can be periodically flushed through the cell passage of the electrochemical cell. The liquid electrode cleansing composition can be selected from the group consisting of an anticorrosion agent, descaling agent, and mixtures thereof the unattached electrolytic device. Common household vinegar can be an example of an anticorrosion agent or descaling agent.

Another embodiment of the present invention relates to an automatic dishwashing appliance containing a cell and/or device, the electrochemical cell comprising a cell regeneration means to extend the operating life of the at least one pair of electrodes by descaling or unfouling the at least one pair of electrodes. The electrochemical cell regeneration means can comprise periodic addition of a liquid electrode cleansing composition through the cell passage of the electrochemical cell, wherein the liquid electrode cleansing composition can be selected from the group consisting of an anticorrosion agent, descaling agent, and mixtures thereof the cell and/or device. The liquid electrode cleansing composition can be vinegar.

Another means for cell regeneration involves polarity reversal of the battery or batteries to minimize or prevent the deposit of scale and the plating of any changed chemical species onto the electrode surfaces. The electrical current supply can further comprise a circuit for periodically reversing the output polarity of the electrical current supply in order to maintain a high level of electrical efficacy over time. The electrochemical cell regeneration means can also comprise a means for periodically reversing the polarity of the at least one pair of electrodes themselves.

The following U.S. Patents disclose electrochemical cell regeneration means and methods:: U.S. Pat. No. 5,954,939; U.S. Pat. No. 4,434,629; U.S. Pat. No. 5,932,171; JP Application No. 10057297A; and WO Patent Number 00/64325.

Local Source of Halogen Ion

An optional embodiment of the present invention includes an electrolytic device comprising a local source of halogen ions, and a means for delivering the local source of halogen ions to at least some of the aqueous electrolytic solution in fluid communication with the inlet opening. This embodiment can be advantageously used in those situations when the aqueous electrolytic solution has a very low concentration, or even no, halogen ions, thereby increasing the production of halogenated mixed oxidants in the effluent as compared to the production of halogenated mixed oxidants from the automatic dishwashing appliance washing basin alone. Preferably, the local source of halogen ion passes through the electrochemical cell, to maximize the conversion of the local source of halogen ion to halogenated mixed oxidants, and to limit adding salts to the aqueous electrolytic solution generally. The local source of halogen ions can supplement the ordinary levels of halogen ion in many water sources, such as tap water, to generate extraordinarily high concentrations of halogenated mixed oxidants in the discharge effluent.

The local source of halogen ions can be from a detergent and/or rinse aid composition, a concentrated brine solution, a halogenated salt tablet, granule, or pellet in fluid communication and/or contact with the aqueous electrolytic solution, or in a porous basket hanging on the rack of the automatic dishwashing appliance, or both. Though, a brine solution can be provided within a brine chamber that can be position in fluid communication with the inlet port of the electrochemical cell via a tube, such that a flow of brine solution will be induced through the tube by venturi suction in response to the flow of water through the inlet port, whereby a constant proportion of brine solution can be delivered, a preferred localized source of halogen ions can be a solid form, such as a pill or tablet, of halide salt, such as sodium chloride (common salt) or sodium chlorite which can be delivered in a porous basket that can be hung on the rack of the appliance.

The means for delivering the local source of halogen ions can comprise a salt chamber or a porous basket comprising the halogenated salt, preferably a pill of tablet, through which at least some of the aqueous electrolytic solution will pass, thereby dissolving at least some of the halide salt into the portion of water. The salted portion of water then ultimately passes into the electrochemical cell. The salt chamber or a porous basket can comprise a salt void that can be formed in the body and positioned in fluid communication with the portion of water that will pass through the electrochemical cell.

Other halogen salts with a substantially lower solubility in water can be advantageously used to control the rate of dissolution of halogenated salt. Preferred salts for use as a solid form of the local source of halogen ion are the less soluble salts, such as calcium chloride, magnesium chloride, calcium chlorite, magnesium chlorite,. The pill can also be formulated with other organic and inorganic materials to control the rate of dissolution of the sodium chloride or sodium chlorite. Preferred can be a slow dissolving salt tablet, to release sufficient halogen ions to effect the conversion of an effective amount of halogenated mixed oxidants. The release rate halogen ion can be typically between 0.01 to 0.3 mg halogen ion for each liter of electrolytic solution treated. The halogenated pill can be a simple admixture of the salt with the dissolution restricting materials, which can be selected from various well-known encapsulating materials.

Storage and Dispensing Means

Another embodiment of the present invention relates to an automatic dishwashing appliance comprising a storage means for storing at least one product prior to its release. The storage means can comprise at least one sealed or sealable compartment located within the appliance, the cell, and/or the device for containing the at least one product, such that the at least one product can be released in conjunction with at least one predetermined point in time during the wash and/or rinse cycle of the appliance. The sealed or sealable compartment can house at least one product, and can be recloseable or resealable such that the compartment's contents are not contaminated by an external medium. The storage means that ensures that the compartment's contents are not contaminated by an external medium can be achieved via a one-way valve, which allows products to flow outside but avoids contamination of the interior of the compartment from an outside medium. Additional compartments located within the appliance, the cell, and/or device can provide for the discharge of an additional product into the washing basin of the dishwashing appliance, into the aqueous electrolytic solution, and combinations thereof, during operation.

The storage means will allow the storage of at least one product prior to its release at specific intervals or time periods through the wash and/or rinse cycles. The dispensing or release of the at least one product can also be in conjunction with at least one predetermined point in time during the wash and/or rinse cycle of the appliance.

Suitable examples of storage and dispensing means, storage devices, and methods of using storage means include, but are not limited to, those found in the following: U.S. Pat. No. 6,338,351; U.S. Pat. No. 6,058,946; U.S. Pat. No. 5,839,454; U.S. Pat. No. 4,800,906; U.S. Pat. No. 3,827,600; and U.S. Pat. No. 3,612,074.

Communication Means

Another embodiment of the present invention relates to an automatic dishwashing appliance comprising a means for communicating to the consumer when it can be time to refill or replace the disposable electrolytic components, such as the electrochemical cell, device, product refill and/or cartridge, a porous basket comprising product for dispensing, valve, filter, etc. The communication means can comprise an indicator, and optionally a controller, CPU, timer and/or sensor for communicating to the consumer when the need for replacement or cleaning can be at hand.

Suitable examples of communication means, communication devices, and methods of using communicating include, but are not limited to, those found in the following: U.S. Pat. No. 6,295,004; U.S. Pat. No. 6,196,239; U.S. Pat. No. 5,839,458; U.S. Pat. No. 5,151,884; U.S. Pat. No. 4,653,423; U.S. Pat. No. 4,213,338; U.S. Pat. No. 4,164,197; U.S. Pat. No. 3,648,931; and U.S. Pat. No. 3,850,185.

Elastomeric Slit Value

One means to ensure that the compartment's contents are not contaminated by an external medium can be achieved by a one-way valve. The one-way value allows products to flow outside the sealed or sealable compartment but avoids contamination, such as to the interior of cell and/or device's from an outside medium. A non-limiting example of the one-way valve can be a disposable elastomeric slit valve.

Suitable examples of elastomeric slit valves and methods of using one-way valves include, but are not limited to, those found in the following: U.S. Pat. No. 5,360,198; U.S. Pat. No. 4,870,986; U.S. Pat. No. 4,824,075; U.S. Pat. No. 4,819,691; U.S. Pat. No. 4,694,847; U.S. Pat. No. 4,193,417; U.S. Pat. No. 4,185,654; and U.S. Pat. No. 4,151,979.

Commercial Automatic Dishwashing Appliances

The wash/rinse/dry process in a commercial automatic dishwashing appliance is typically 2 to 5 minutes long (average is around 2.5 minutes). In fact, the water temperature in a commercial appliance may be as high as 60-70 degrees C. during the wash and/or rinse cycle. Electrochemical cells and/or electrolytic devices of the present invention allow for disinfectancy of tableware during the wash and/or rinse cycle(s) of commercial appliances without the need for high temperatures or the addition of dangerous chemicals, like hypochlorite. In fact, disinfectancy can be achieved by the present invention without adding additional heat, such as at water temperatures below 48 degrees C. In addition, during a wash and/or rinse cycle with an average process time of about 2.5 minutes, the present invention may comprise a high throughput electrochemical cell and/or device (or set of devices) in order to achieve the required disinfectancy without the need to use hypochlorite.

Alternatively, the electrochemical cell and/or device may also be used to control, at any selected level, the microbiological contamination of the water in a commercial automatic dishwashing appliance, especially for conveyor-low-temperature type, cabinet-low-temperature type, and combinations thereof. Thus, the commercial appliance may use water temperatures ranging from cold tap water to heated wash and/or rinse liquor up to about 70 degrees C. to reduce microbial contamination.

Using electrolyzed water in the present invention reduces odors caused by the use of hypochlorite while at the same time generating low-temperature active anti-microbials in the form of halogenated mixed oxidants. The benefit results from preventing bad smell in the kitchen area, especially useful in restaurants and bars. Furthermore, the disinfection of other types of water storage systems in commercial applications could be also accomplished with the present invention without the need of high temperature and/or hypochlorite addition.

Methods of Use

The electrolyzed water that can be discharged by the cell and/or device can effectively sanitize the aqueous electrolytic solution comprising tap water, wash and/or rinse liquor, recirculated wash and/or rinse liquor, and mixtures thereof, making the aqueous electrolytic solution useful for treating tableware by providing cleaning, stain removal and sanitization benefits in both commercial, as well as, in residential applications.

The automatic dishwashing appliance containing a recirculating cell and/or device of the present invention can be used for all types of cleaning, stain removal and sanitizing or disinfecting tableware, and, in conjunction with a separate composition, such as, at least one product selected from the group consisting of detergent compositions, rinse aid composition, a solid electrolysis precursor compound of low water solubility, an electrolysis precursor compound containing a matrix of low water solubility, and mixtures thereof.

Another embodiment of the present invention relates to a method of sanitizing or disinfecting tableware in automatic dishwashing appliance without requiring additional heating of the wash and/or rinse liquor, the steps of the method comprising: (a) placing tableware in need of treatment into the appliance; (b) providing a cell and/or device, wherein the cell comprising at least one inlet opening and one outlet opening, and at least one pair of electrodes defining at least one cell gap comprising at least one cell passage formed therebetween through which an aqueous electrolytic solution can flow; (c) providing the aqueous electrolytic solution in fluid communication with the cell via the inlet opening; (d) electrolyzing the aqueous electrolytic solution in the cell and/or device to produce at least some electrolyzed water; (e) discharging an effluent comprising the electrolyzed water into the washing basin of the dishwashing appliance at a specific time or times in the wash and/or rinse cycle; (f) applying no additional heat to the wash and/or rinse liquor in the wash and/or rinse cycle(s) of the appliance; (g) contacting the tableware in need of treatment with at least some electrolyzed water comprising wash and/or rinse liquor; and (h) optionally repeating steps (c) through (g) until the tableware are treated.

Another embodiment of the present invention relates to a method, wherein said cell can be selected from the group consisting of energy saving, partitioned, non-partitioned, robust, recirculating, non-recirculating, and combinations thereof.

Another embodiment of the present invention relates to a method, after placing tableware in need of treatment into the appliance, further comprising the steps of removing and/or replacing a used refill and/or replacement cartridge and inserting a new refill and/or replacement cartridge into the appliance and/or electrolytic device; wherein the used refill and/or replacement cartridge comprising a component selected from the group consisting of electrochemical cell, recirculating, dual-purpose cell, electrolytic device which comprises an electrochemical cell, product, filter, elastomeric slit valve, porous basket comprising a product for dispensing, and combinations thereof.

Another embodiment of the present invention relates to a method, wherein after providing a cell and/or device, the method can further comprise step of providing and dispensing at least one product selected from the group consisting of electrolytic solution containing chloride ions, chlorite ions, electrolytic solution containing salts having the formula (M)ₓ(XO₂)_{y} and/or (M)ₓ(X)_{y} wherein X can be Cl, Br, or I, wherein M can be a metal ion or cationic entity, and wherein x and y are chosen such that the salt can be charge balanced, electrolysis precursor compounds, electrolysis salts with low water solubility, electrolysis precursor compounds contained within a medium for controlled release, electrolyzed water, detergent compositions, rinse aid compositions, electrode cleaning agents, bleach-scavenging agents, metal-protecting agents, adjunct ingredients, and mixtures thereof.

Another embodiment of the present invention relates to a method, wherein during operation of the appliance at least some product undergoes electrolysis, does not undergo electrolysis, and/or combinations thereof. The medium for controlled release of a product can comprise a form such that once placed inside a dishwashing appliance it provides a controlled release of electrolysis salts into the wash and/or rinse liquors during operation. The form can be solid, liquid, gel, and/or combination thereof, and can release product over a period of several weeks or months of regular household and/or commercial use.

Another embodiment of the present invention relates to a method can further comprise the steps of providing a product comprising a bleach-scavenging agent and/or metal protection agent, and discharging the product subsequent to the period or periods of electrolysis, or during one or more of the rinses, and after which no further electrolyzed water comes into contact with the tableware.

Another embodiment of the present invention relates to a method, wherein the electrolyzed discharge effluent can be discharged only during one or more of the rinse cycles of the appliance. The electrolyzed discharge effluent can comprise hypochlorite and/or chlorine dioxide.

Another embodiment of the present invention relates to a method of using an appliance comprising a cell and/or device in conjunction with a composition selected from the group consisting of separate an electrolysis precursor composition of low water solubility, an electrolysis precursor compound contained in a medium for controlled release, and mixtures thereof, the separate electrolysis precursor composition comprising salts having the formula (M)ₓ(XO₂)_{y} and/or (M)ₓ(X)_{y} wherein X can be Cl, Br, or I, wherein M can be a metal ion or cationic entity, and wherein x and y are chosen such that the salt can be charge balanced.

Another embodiment of the present invention relates to an energy-saving method, wherein the total energy consumption can be less than about 1.8 kWh per operating cycle or about 600 kWh per year, preferably less than about 1.7 kWh per operating cycle and/or about 555 kWh per year, most preferably less than about 1.2 kWh per operating cycle and/or about 400 kWh per year, and wherein the total energy consumption of the appliance includes any energy used to heat wash and/or rinse liquor in the appliance. The energy-saving cell and/or device can be selected form the group consisting of partitioned, non-partitioned, robust, recirculating, non-recirculating, and combinations thereof.

Disposable and/or Replaceable Components of Cell and/or Device

The components of attached, integrated electrochemical cells and/or electrolytic devices in the present invention are disposable and/or replaceable, and can be partitioned and/or non-partitioned, recirculating, non-recirculating, and combinations thereof. These components can be selected from the group consisting of an electrochemical cell, recirculating, dual-purpose cell, electrolytic device which comprises an electrochemical cell, refill and/or replacement cartridge comprising a product for dispensing, filter, elastomeric slit valve, porous basket comprising a product for dispensing, and combinations thereof.

An Article of Manufacture

The present invention can also comprise an article of manufacture for an automatic dishwashing appliance comprising a refill or replacement cartridge of the optional replaceable components of the cell and/or device. The replaceable components can be selected from the group consisting of electrochemical cell, recirculating, dual-purpose cell, electrolytic device which comprises an electrochemical cell, refill and/or replacement cartridge comprising a product for dispensing, filter, elastomeric slit valve, porous basket comprising a product for dispensing, liquid electrode cleansing composition, and combinations thereof.

Another embodiment of the present invention relates to an article of manufacture for an automatic dishwashing appliance comprising (a) a package; (b) a replacement component for said appliance selected from the group consisting of a: (i) replacement electrochemical cell and/or electrolytic device, (ii) replacement automatic dishwashing composition comprising a component selected from the group consisting of suds suppressor, perfume, bleach-scavenging agent, metal-protecting agent, and mixtures thereof; (iii) replacement product comprising a component selected from electrolytic solution comprising chloride ions, an electrolytic composition comprising chlorite ions, electrolytic solution comprising salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, electrolysis precursor compound, an electrolysis salt with low water solubility, an electrolysis precursor compound contained within a medium for controlled release, and mixtures thereof, wherein said product optionally housed in a porous basket; (iv) replacement filter or screen for said unattached electrolytic device; (v) replacement elastomeric slit valve; (vi) replacement a porous basket comprising product for dispensing; and (vii) combinations thereof; and (c) information in association with said package comprising instructions to insert said replacement components in said appliance and/or said electrolytic device.

The article of manufacture can also comprise a separate composition in a form such that once placed inside a dishwashing appliance it provides a controlled release of electrolysis salts into the wash and/or rinse liquors during operation of an automatic dishwashing appliance over a period of several weeks or months of regular household and/or commercial use.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1-95. (canceled)

96. An automatic dishwashing appliance having a washing basin for treating tableware to provide an improvement in cleaning, sanitizing, and/or stain removal, said appliance comprising a source of electrical current supply, and an attached, integrated, recirculating electrochemical cell and/or an electrolytic device comprising said recirculating cell; wherein said recirculating cell comprises at least one inlet opening and one outlet opening, and at least one pair of electrodes defining at least one cell gap comprising at least one cell passage formed therebetween through which an aqueous electrolytic solution can flow and a filtering means to minimize fouling of said cell passage from flow of said recirculated electrolytic solution through said cell passage; wherein at least some of said aqueous electrolytic solution recirculates through said recirculating cell and is discharged into said appliance as an electrolyzed discharge effluent; and a non-recirculating cell and/or device, wherein said non-recirculating cell and/or device does not allow for recirculation of wash and/or rinse liquor; wherein the only water treated by said cell and/or device is tap water from an incoming tap water supply; wherein when tap water is treated and discharged from said non-recirculating cell and/or device as discharge effluent, said discharge effluent comprises at least some electrolyzed tap water; and wherein said filtering means, said recirculating cell and said non-recirculating cell are all self-cleaning via periodic flushing with water without the application of power for electrolysis.

97. An appliance according to claim 96, wherein said recirculated electrolytic solution comprises at least some electrolyzed water from electrolysis of a water supply source selected from the group consisting of incoming tap water, recirculated wash and/or rinse liquors, and mixtures thereof.

98. An appliance according to claim 96, wherein said source of electrical current supply is alternating current.

99. An appliance according to claim 98, wherein said source of electrical current supply is drawn from said appliance's internal electric current or from the household electrical current from which said appliance draws its electrical current.

100. An appliance according to claim 96, wherein said source of electrical current supply comprises at least one battery, at least one rechargeable battery, and mixtures thereof; wherein the operating voltage of said recirculating cell and/or device is between about 1.5 to about 12 volts.

101. An appliance according to claim 96, wherein said appliance allows for at least some wash and/or rinse liquor to: (a) continuously pass through said recirculating cell and/or device as a discharge effluent, (b) be bypassed back into the washing basin of said appliance without undergoing electrolysis, and (c) combinations thereof; wherein when recirculating wash and/or rinse liquor is discharged from said recirculating cell and/or device, said discharge effluent comprises at least some electrolyzed recirculated wash and/or rinse liquor.

102. An appliance according to claim 96, wherein said recirculating cell is disposable and/or replaceable.

103. An appliance according to claim 96, wherein said recirculating cell and/or device is non-partitioned.

104. An appliance according to claim 96, wherein said recirculating cell and/or device is partitioned.

105. An appliance according to claim 104, wherein said pair of electrodes comprises at least one anode and at least one cathode, wherein all or part of the electrolyzed water is split into two separate streams, an anode stream and a cathode stream, and wherein said split streams are optionally used separately at different times during the wash and/or rinse cycles of said appliance and for different purposes.

106. An appliance according to claim 96, wherein said recirculating cell and/or electrolytic device further comprises a means for activating and/or deactivating said recirculating cell and/or device to enable and/or disable electrolysis at specific time intervals throughout the wash and/or rinse cycles of said appliance.

107. An appliance according to claim 106, wherein said means of activation and/or deactivation of said recirculating cell and/or device comprises at least one sensor capable of analyzing and/or detecting a target composition of the fluid or gaseous environment within said appliance, recirculating cell, and/or device, and wherein when said sensor detects said target composition, said sensor provides an electric and/or electronic signal to said appliance, recirculating cell, and/or device, to activate and/or deactivate said recirculating cell and/or device.

108. A appliance according to claim 107, wherein said target composition comprises a volatile compound or gas selected from the group consisting of perfumes, perfume raw materials, volatile organic compounds, inorganic gases, and mixtures thereof.

109. An appliance according to claim 107, wherein said sensor is selected from the group consisting of turbidity sensor, water hardness sensor, pH sensor, conductivity sensor, and combinations thereof.

110. An appliance according to claim 96, wherein said recirculating cell comprises at least one cathode of stainless steel and at least one anode of titanium, and wherein said anode is coated and/or layered with at least one of the materials selected from the group consisting of platinum, ruthenium iridium, and oxides, alloys, and mixtures thereof.

111. An appliance according to claim 110, wherein said recirculating cell is non-partitioned, having a cell gap between said pair of electrodes with a spacing between about 0.1 mm to about 0.5 mm.

112. An appliance according to claim 96, further comprising a storage means for storing at least one product prior to its release.

113. An appliance according to claim 112, wherein said product is in the form selected from the group consisting of a tablet, pellet, prill, powder, gel, liquid, and combinations thereof.

114. An appliance according to claim 112, wherein said product is selected from the group comprising electrolytic solution containing chloride ions, chlorite ions, electrolytic solution containing salts having the formula (M)ₓ(XO₂)_{y} and/or (M)ₓ(X)_{y} wherein X is Cl, Br, or I, wherein M is a metal ion or cationic entity, and wherein x and y are chosen such that said salt is charge balanced, electrolysis precursor compounds, electrolysis salts with low water solubility, electrolysis precursor compounds contained within a medium for controlled release, electrolyzed water, detergent compositions, rinse aid compositions, electrode cleaning agents, bleach-scavenging agents, metal-protecting agents, adjunct ingredients, and mixtures thereof.

115. An appliance according to claim 96, wherein said appliance further comprises a means for communicating to the consumer when it is time to refill and/or replace a component selected from the group consisting of a recirculating cell, recirculating dual-purpose cell, recirculating device comprising said recirculating cell, product refill and/or replacement cartridge, filter, elastomeric slit valve, porous basket comprising a product for dispensing, and combinations thereof.
